(19) United States
(12) Patent Application Publication
(10) Pub. No.: US 2026/0058205 A1
(43) Pub. Date: Feb. 26, 2026

(54) TUNING THE SOLVATION STRUCTURE THROUGH SALTS FOR STABLE BATTERIES

(71) Applicant: BOARD OF REGENTS, THE UNIVERSITY OF TEXAS SYSTEM, Austin, TX (US)

(72) Inventors: Arumugam MANTHIRAM, Austin, TX (US); Jiarui HE, Austin, TX (US); Amruth BHARGAV, Austin, TX (US)

(21) Appl. No.: 19/103,414

(22) PCT Filed: Aug. 2, 2023
(86) PCT No.: PCT/US2023/029298

§ 371 Date: Feb. 12, 2025

Related U.S. Application Data
(60) Provisional application No. 63/399,388, filed on Aug. 19, 2022.
(60) Provisional application No. 63/481,680, filed on Jan. 26, 2023.

(51) Int. Cl. H01M 10/0568; H01M 4/02; H01M 4/131; H01M 4/134; H01M 4/38; H01M 4/505; H01M 10/0525

(52) U.S. Cl. CPC H01M 10/0568; H01M 4/131; H01M 4/134; H01M 4/381; H01M 4/505; H01M 10/0525; H01M 2004/027; H01M 2004/028

(57) ABSTRACT

Disclosed is an electrolyte comprising: a first salt, wherein the first salt is an active material salt; a second salt; and a solvent, wherein the first salt and the second salt are dissolved in the solvent, such that the dissolved first salt has a solvation structure; wherein a solubility of the first salt in the solvent is greater than about 2 M; wherein the second salt is different from the first salt and has a solubility in the solvent lower than about 2 M; wherein the second salt behaves as a diluent and is at least partially incorporated into the solvation structure; such that the solvation structure is substantially dominated by a plurality of solvent-separated pairs, contact-ion pairs, aggregates or a combination thereof. Also disclosed are electrochemical cells comprising such electrolytes. Also disclosed are methods of making the disclosed herein electrolytes and electrochemical cells.

### CROSS-REFERENCE TO RELATED APPLICATIONS

This application claims the benefit of U.S. Provisional Application No. 63/399,388, filed Aug. 19, 2022, and U.S. Provisional Application No. 63/481,680, filed Jan. 26, 2023, the contents of which are incorporated herein by reference in their entirety.

### STATEMENT ACKNOWLEDGING GOVERNMENT SUPPORT

This invention was made with government support under Grant Nos. DE-SC0005397 awarded by the Department of Energy. The government has certain rights in the invention.

### TECHNICAL FIELD

This application relates generally to electrolytes for the stable operation of electrochemical cells.

### BACKGROUND

With the rapid increase in portable electronics and the global push towards vehicle electrification and smart grids, there is an increasing demand for large-scale, sustainable, eco-friendly, safe electrochemical energy storage systems (such as batteries, for example) with high energy/power density.

Electrolytes provide ionic conductivity through the battery between the cathodes and anodes. The properties of the electrolyte can significantly influence the battery's performance. It is also desirable for the batteries to operate over a large number of charge-discharge cycles so that the batteries can provide a larger economic value.

It has been found that in conventional electrolyte systems with low salt concentrations (<1 M), the decomposition of free solvent molecules on the surface of the anode and cathode leads to the formation of unstable SEI and CEI. Increasing the salt concentration to ≥4 M produces high-concentration electrolytes (HCEs), which have salt-solvent complexes consisting of contact-ion pairs (CIPs) and ion aggregates (AGGs). In such electrolytes, the electrolyte salt primarily decomposes to foster an SEI and CEI rich in inorganic phases that stabilize the anode and the cathode. To reduce the viscosity and improve the ionic conductivity while maintaining the solvation structure, localized high-concentration electrolytes (LHCE) have been introduced by adding a non-solvating liquid diluent into HCE. Fluoroethers, such as bis(2,2,2-trifluoroethyl) ether (BTFE) and 1,1,2,2-tetrafluoroethyl-2,2,3,3-tetrafluoropropyl ether (TTE), have emerged as the diluents of choice in making LHCEs. Unfortunately, these fluoroether diluents are expensive (Table 1) and flammable. It is also interesting to note that HCEs and LHCEs with non-flammable solvents like triethyl phosphate (TEP) and trimethyl phosphate (TMP) have been reported for Li-ion batteries. However, these still rely on fluoroether-based diluents and hence impede the cost advantages offered by sodium batteries. To ensure the economic sustainability of SMBs, it is crucial to develop advanced, cost-effective, safe LHCEs that can simultaneously protect the anode and cathode.

Thus, innovative approaches to providing stable and efficient batteries having cost-effective, safe and efficient electrolytes are needed. These needs and other needs are at least partially satisfied by the present disclosure.

### SUMMARY

The present disclosure is directed to an electrolyte comprising: a first salt, wherein the first salt is an active material salt; a second salt; and a solvent, wherein the first salt and the second salt are dissolved in the solvent, such that the dissolved first salt has a solvation structure; wherein a solubility of the first salt in the solvent is greater than about 2 M; wherein the second salt is different from the first salt and has a solubility in the solvent lower than about 2 M; wherein the second salt behaves as a diluent and is at least partially incorporated into the solvation structure; such that the solvation structure is substantially dominated by a plurality of solvent-separated pairs, contact-ion pairs, aggregates or a combination thereof.

In further aspects, the first salt is present in a concentration from about 1 M to about 2 M. In other aspects, the second salt is present in a concentration of less than about 1 M.

While in still further aspects, the solvation structure of the first salt further comprises the solvent that is not associated with the first and/or second salt.

In still further aspects, when the disclosed herein electrolyte is used in an electrochemical cell, the electrolyte is capable of forming an inorganic-rich interface layer on at least one electrochemically active surface during an operation of the electrochemical cell.

In further aspects, disclosed herein is an electrochemical cell comprising: at least one electrochemically active surface; any of the disclosed herein electrolytes; an inorganic-rich interface layer disposed at the at least one electrochemically active surface during an operation of the electrochemical cell; and wherein the electrochemical cell is configured to provide at least about 100 cycles of stripping/platting.

In yet still, further aspects, disclosed herein is the electrochemical cell, where the electrolyte comprises: the first salt comprising NaFSI; the second salt comprising NaNO₃; the solvent comprising trimethyl phosphate; the anode comprises a sodium metal or a sodium ion; and the cathode comprises sodium nickel-iron-manganese oxide.

Further disclosed herein are methods of making of any of the electrolytes disclosed herein.

Still further disclosed herein are methods of making any of the electrochemical cells disclosed herein.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and is not restrictive of the invention, as claimed.

### BRIEF DESCRIPTION OF DRAWINGS

FIGS. 1A-1B depict an electrolyte design strategy. FIG. 1A is an illustration of the components with a Na-metal battery after long-term cycling in (left) carbonate-based electrolyte and (right) NaFSI—NaNO₃-TMP electrolyte. FIG. 1B shows flammability tests of carbonate-based electrolyte, conventional LHCE, and NaFSI—NaNO₃-TMP electrolyte.

FIGS. 2A-2C depict the behavior of different electrolyte formulations. FIG. 2A shows FTIR spectra of various electrolytes and the TMP solvent. FIG. 2B shows NMR spectra of ³¹P in the TMP solvent and a few investigated electrolytes. FIG. 2C shows snapshots of the entire unit cell figures with detailed solvation structure of Na⁺ ions in 0.6 M NaNO₃, 1.1M NaFSI in TMP, 3 M NaFSI in TMP, and NaFSI—NaNO₃-TMP electrolyte.

FIGS. 3A-3F show the electrochemical behavior of NFM in Na∥NFM cells in different electrolytes. FIG. 3A shows the cycling performance of NFM with a low active material loading (5 mg cm⁻²). Voltage profiles of NFM in carbonate electrolyte (FIG. 3B) and NaFSI—NaNO₃-TMP electrolyte (FIG. 3C). FIG. 3D shows the cycling performance of NFM with a high active material loading (12.5 mg cm⁻²). FIG. 3E shows cycling performances of Na∥NFM pouch cells. FIG. 3F shows cycling performances of anode-free Ni∥NFM cells.

FIGS. 4A-4J show the characterization of NFM cathode in Na∥NFM cells with different electrolytes. FIGS. 4A-4B show the charge and discharge curves of a Na(Ni_{0.3}Fe_{0.4}Mn_{0.3})O₂ coin cell and the corresponding diffraction patterns with carbonate electrolyte (FIG. 4A) and NaFSI—NaNO₃-TMP electrolyte (FIG. 4B). Selected diffraction peaks are labeled. FIGS. 4C-4D show the evolution of Na(Ni_{0.3}Fe_{0.4}Mn_{0.3})O₂ lattice parameters with the carbonate electrolyte during charging. Only the charge process data were analyzed and shown here because the phase evolution is reversible during the discharge process. FIGS. 4E-4F show evolution of Na(Ni_{0.3}Fe_{0.4}Mn_{0.3})O₂ lattice parameters with the NaFSI—NaNO₃-TMP electrolyte during charging. FIGS. 4G-4J show depth profiles and 3D visualization of architecture evolution of cycled NFM with carbonated electrolyte (FIGS. 4A-4H) and NaFSI—NaNO₃-TMP electrolyte (FIGS. 4I-4J).

FIGS. 5A-5C show Na plating and stripping behaviors in different electrolytes. FIG. 5A shows the coulombic efficiency of Na plating/stripping using Cu electrodes at 1 mA cm⁻² with an areal capacity of 1 mAh cm⁻². FIG. 5B shows galvanostatic cycling performances of Na∥Na symmetric coin cells with various electrolytes. FIG. 5C shows the galvanostatic cycling performance of Na∥Na symmetric pouch cell with NaFSI—NaNO₃-TMP electrolyte.

FIGS. 6A-6J show the characterization of cycled Na in Na∥NFM cells in different electrolytes. Top-surface and cross-sectional morphologies of cycled Na in Na∥NFM cell with carbonated electrolyte (FIGS. 6A-6B) and NaFSI—NaNO₃-TMP electrolyte (FIGS. 6D-6E). In situ optical microscopy observations of the Na deposition process with carbonate electrolyte (FIG. 6C) and NaFSI—NaNO₃-TMP electrolyte (FIG. 6F). Depth profiles and 3D visualization of architecture evolution of cycled Na in Na∥NFM cells with carbonate electrolyte (FIGS. 6G-6H) and NaFSI—NaNO₃-TMP electrolyte (FIGS. 6I-6J).

FIG. 7 depicts an XRD pattern of pristine Na(Ni_{0.3}Fe_{0.4}Mn_{0.3})O₂.

FIG. 8 depicts the cycling performances of NFM with a low active material loading in 1.1 M NaFSI in TMP electrolyte and NaFSI—NaNO₃-TMP electrolyte.

FIG. 9 depicts the cycling performances of NFM with a low active material loading in LHCE and NaFSI—NaNO₃-TMP electrolyte.

FIG. 10 shows the rate performances of NFM in carbonate electrolyte and NaFSI—NaNO₃-TMP electrolyte.

FIG. 11 shows Nyquist plots showing the impedance evolution of charged NFM cathodes (4 V vs. Na⁺/Na) in a Na∥NFM pouch cell after 1^{st} cycle and 76 cycles.

FIG. 12 shows the cycling performances of NFM in carbonate electrolyte and NaFSI—NaNO₃-TMP electrolyte at 60° C.

FIGS. 13A-13F show photographs of the separators, NFM cathodes, and Na anodes of the cycled cells with carbonate electrolyte or NaFSI—NaNO₃-TMP electrolyte at 60° C.

FIG. 14 shows DSC profiles of fully charged NFM combined with carbonate electrolyte and NaFSI—NaNO₃-TMP electrolyte.

FIG. 15 depicts a photo of the operando synchrotron-based XRD experimental setup at sector 6BM-A of the Advanced Photo Source in Argonne National Laboratory.

FIGS. 16A-16C show TEM images of cycled NFM in carbonate electrolyte (FIG. 16A) and NaFSI—NaNO₃-TMP electrolyte (FIG. 16B). FIG. 16C shows intensity profiles corresponding to the regions (either surface or bulk) indicated in FIGS. 16A-16B.

FIGS. 17A-17C show SEM images of pristine NFM (FIG. 17A) and cycled NFM in NaFSI—NaNO₃-TMP electrolyte (FIG. 17B) and cycled NFM in carbonate electrolyte (FIG. 17C).

FIGS. 18A-18F show XPS data of cycled NFM cathodes in the two investigated electrolytes: Na 1s (FIG. 18A), S 2p (FIG. 18B), and N 1s (FIG. 18C) spectra of the NFM cathode in Na∥NFM cells with carbonate electrolyte. Na 1s (FIG. 18D), S 2p (FIG. 18E), and N 1s (FIG. 18F) spectra of the NFM cathode in Na∥NFM cells with NaFSI—NaNO₃-TMP electrolyte.

FIGS. 19A-19B show Na plating/stripping profile evolutions in NaFSI—NaNO₃-TMP electrolyte (FIG. 19A) and carbonate electrolyte (FIG. 19B) at 1 mA cm⁻² with an areal capacity of 1 mAh cm⁻².

FIG. 20 shows Nyquist plots of the impedance spectra of Na∥Na symmetric cell with NaFSI—NaNO₃-TMP electrolyte.

FIG. 21 shows the rate performances of Na∥Na symmetric cell with NaFSI—NaNO₃-TMP electrolyte.

FIG. 22 depicts In situ optical microscopy observations of the Na deposition process in carbonate electrolyte and NaFSI—NaNO₃-TMP electrolyte.

FIGS. 23A-23F show XPS data of cycled Na anodes in the two investigated electrolytes: Na 1s (FIG. 23A), S 2p (FIG. 23B), and N 1s (FIG. 23C) spectra of the Na anode in Na∥NFM cells with carbonate electrolyte. Na 1s (FIG. 23D), S 2p (FIG. 23E), and N 1s (FIG. 23F) spectra of the Na anode in Na∥NFM cells with NaFSI—NaNO₃-TMP electrolyte.

FIG. 24 shows the cross-sectional SEM image of the exemplary thin Na anode.

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a solvent” includes two or more such solvents, and a reference to “a battery” includes two or more such batteries and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as,” and grammatical equivalences thereof, the phrase “and without limitation” is understood to follow unless explicitly stated otherwise.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell,” refers to a reference composition, article, or an electrochemical cell comprising substantially identical components and wherein an inventive component is substituted with a common in the art component.

As used here, the term “associated” means coordinated to or solvated by. For example, a cation that is associated with a solvent molecule is coordinated to or solvated by the solvent molecule. Solvation is the attraction of solvent molecules with molecules or ions of a solute. The association may be due to electronic interactions (e.g., ion-dipole interactions and/or van der Waals forces) between the cation and the solvent molecule. Coordination refers to the formation of one or more coordination bonds between a cation and electron lone-pairs of solvent atoms. Coordination bonds also may form between the cation and anion of the solute.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Electrolytes and Electrochemical Cells

Sodium-metal batteries are an appealing, sustainable, low-cost alternative to lithium-metal batteries due to the high abundance and theoretical specific capacity (1, 165 mA h g⁻¹) of sodium. However, the poor compatibility of the electrolyte with the cathode and anode leads to unstable electrode-electrolyte interfaces. Localized high-concentration electrolytes (LHCEs) made by diluting a concentrated electrolyte solution with an inert solvent, termed a “diluent,” lead to salt-solvent complexes that form inorganic-rich interfaces and stabilize the interfaces. However, the high cost of the salt and diluent coupled with their flammability hinder their practical viability.

With the rapid increase in portable electronics and the global push towards vehicle electrification and smart grids, there is an increasing demand for large-scale, sustainable, eco-friendly, safe electrochemical energy storage systems with high energy/power density. As an alternative to lithium-based batteries for storing energy, sodium batteries offer great potential as next-generation energy storage systems due to their economic sustainability, considering the highly abundant, wide distribution, and low cost of sodium minerals. The high theoretical specific capacity (1,165 mA h g⁻¹) and low redox potential (−2.714 V vs. standard hydrogen electrode) of sodium metal make it an attractive anode in sodium-metal batteries (SMBs).

The high reactivity of Na leads to poor electrode-electrolyte interfaces at both the anode and the cathode that need to be resolved for the practical viability of SMB. Owing to the low potential of Na, typically, both the electrolyte salt and the solvent get reduced to form a solid-electrolyte interface (SEI). With most electrolytes, this is not a self-limiting reaction, which causes uncontrolled growth of Na dendrites, leading to continuous consumption of the electrolyte and an irretrievable loss of Na inventory by the detrimental reactions. The formed dendrites may pierce the separator resulting in an internal short circuit, causing safety issues involving thermal runaway and explosion of the flammable electrolyte. At the cathode, it is preferable to use a high-energy layered oxide cathodes made of sustainable elements. In certain aspects, the cathode can be Na(Ni_{0.3}Fe_{0.4}Mn_{0.3})O₂ (NFM). Yet in other aspects, the cathode has a very low Ni content. In still in other aspects, the cathode comprises substantially no Ni content. Unfortunately, with the NFM cathode, the O3 to P3 phase transition occurring at low voltages (<3.3 V vs. Na/Na⁺) leads to a sudden volume change due to the gliding of the layers. The repeated volume change during cycling causes primary and secondary particle cracking in the NFM cathode. Exposure of these cracked particles to the electrolyte at high voltages (around 4 V vs. Na/Na⁺) leads to electrolyte oxidation and the formation of a cathode-electrolyte interface (CEI). The continuous formation of CEI hinders Na-ion and electron transport, resulting in impedance growth and capacity fade. Therefore, it is urgent to design advanced electrolytes that can help control the growth of Na metal during repeated plating/stripping and stabilize the NFM cathode during long-term cycling.

Several strategies have been pursued to address the issues with the Na-metal anode, including additives, electrolyte design, interfacial modification, and modification of the current collector. For the electrolyte design, it has been found that in conventional electrolyte systems with low salt concentrations (<1 M), the decomposition of free solvent molecules on the surface of the anode and cathode leads to the formation of unstable SEI and CEI. Increasing the salt concentration to ≥4 M produces high-concentration electrolytes (HCEs), which have salt-solvent complexes consisting of contact-ion pairs (CIPs) and ion aggregates (AGGs). In such electrolytes, the electrolyte salt primarily decomposes to foster an SEI and CEI rich in inorganic phases that stabilize the anode and the cathode. To reduce the viscosity and improve the ionic conductivity while maintaining the solvation structure, localized high-concentration electrolytes (LHCE) have been introduced by adding a non-solvating liquid diluent into HCE. Fluoroethers, such as bis(2,2,2-trifluoroethyl) ether (BTFE) and 1,1,2,2-tetrafluoroethyl-2,2,3,3-tetrafluoropropyl ether (TTE), have emerged as the diluents of choice in making LHCEs. Unfortunately, these fluoroether diluents are expensive (Table 1) and flammable. It is also interesting to note that HCEs and LHCEs with non-flammable solvents like triethyl phosphate (TEP) and trimethyl phosphate (TMP) have been reported for Li-ion batteries. However, these still rely on fluoroether-based diluents and hence impede the cost advantages offered by sodium batteries. To ensure the economic sustainability of SMBs, it is crucial to develop advanced, cost-effective, safe LHCEs that can simultaneously protect the anode and cathode.

In certain aspects, disclosed herein is an electrolyte comprising: a first salt, wherein the first salt is an active material salt; a second salt; and a solvent, wherein the first salt and the second salt are dissolved in the solvent, such that the dissolved first salt has a solvation structure; wherein a solubility of the first salt in the solvent is greater than about 2 M; wherein the second salt is different from the first salt and has a solubility in the solvent lower than about 2 M; wherein the second salt behaves as a diluent and is at least partially incorporated into the solvation structure; such that the solvation structure is substantially dominated by a plurality of solvent-separated pairs, contact-ion pairs, aggregates or a combination thereof.

In still further aspects, the solubility of the first salt in the solvent can be greater than about 2 M, for example, it can be in a range from greater than about 2 M to about 10 M, including exemplary values of about 2.5 M, about 3 M, about 3.5 M, about 4 M, about 4.5 M, about 5 M, about 5.5 M, about 6 M, about 6.5 M, about 7M, about 7.5 M, about 8 M, about 8.5 M, about 9 M, and about 9.5 M.

In still further aspects, the solubility of the second salt in the solvent is lower than about 2 M. In such aspects, the solubility of the second salt in the solvent can be from greater than 0 M to less than about 2 M, including exemplary values of about 0.1 M, about 0.2 M, about 0.3 M, about 0.4 M, about 0.5 M, about 0.6 M, about 0.7 M, about 0.8 M, about 0.9 M, about 1 M, about 1.1 M, about 1.2 M, about 1.3 M, about 1.4 M, about 1.5 M, about 1.6 M, about 1.7 M, about 1.8 M, and about 1.9 M.

It is further understood that while the solubility of the first salt can be from greater than about 2 M to about 10 M, the first salt does not have to be present up to its solubility saturation. In such aspects, the first salt can be present in any concentration below its saturation point. For example, the first salt can be present in a concentration from greater than about 2 M to less than about 10 M, including exemplary values of about 0.5 M, about 3 M, about 3.5 M, about 4 M, about 4.5 M, about 5 M, about 5.5 M, about 6 M, about 6.5 M, about 7M, about 7.5 M, about 8 M, about 8.5 M, about 9 M, and about 9.5 M. In yet still further aspects, the first salt is present in the concentration from about 1 M to about 2 M, including exemplary values of about 1.1 M, about 1.2 M, about 1.3 M, about 1.4 M, about 1.5 M, about 1.6 M, about 1.7 M, about 1.8 M, and about 1.9 M.

In still further aspects, similarly to the first salt, while the solubility of the second salt can be from greater than 0 M to lower than about 2 M, the second salt does not have to be present up to its solubility saturation. In such aspects, the second salt can be present in any concentration below its saturation point. For example, the second salt can have a concentration from greater than 0 M to lower than about 2 M, including exemplary values of about 0.1 M, about 0.2 M, about 0.3 M, about 0.4 M, about 0.5 M, about 0.6 M, about 0.7 M, about 0.8 M, about 0.9 M, about 1 M, about 1.1 M, about 1.2 M, about 1.3 M, about 1.4 M, about 1.5 M, about 1.6 M, about 1.7 M, about 1.8 M, about and about 1.9 M. In yet still further aspects, the second salt is present in a concentration of less than about 1 M, including exemplary values of less than about 0.9 M, less than about 0.8 M, less than about 0.7 M, less than about 0.6 M, less than about 0.5 M, less than about 0.4 M, less than about 0.3 M, less than about 0.2 M, or less than about 0.1 M. In yet still further aspects, the second salt can be present in a concentration from greater than 0 M to less than about 1 M, including exemplary values of 0.1 M, about 0.2 M, about 0.3 M, about 0.4 M, about 0.5 M, about 0.6 M, about 0.7 M, about 0.8 M, and about 0.9 M.

It is understood that the solubility (and/or concentration) of the first salt and/or the second salt can be expressed in other units. For example, the solubility of the first salt and/or the second salt in the solvent can be expressed in units of molality or in weight percentage. It is also understood that when the solubility (and/or concentration) of the first salt and/or the second salt is expressed in molal, it is calculated based on the weight of the solvent present in the electrolyte. When the solubility (and/or concentration) of the first salt and/or the second salt is expressed in weight percentage, it is calculated based on the total amounts of the first salt, the second salt and the solvent.

In still further aspects, it is understood that the first salt can comprise one or more active material salts. The active salt is a salt or combination of salts that participate in the charge and discharge processes when the disclosed herein electrolyte is used in an electrochemical cell. The active salt comprises a cation that is capable of forming redox pairs having different oxidation and reduction states, such as ionic species with differing oxidation states or a metal cation and its corresponding neutral metal atom. In further aspects, the first salt can comprise an alkali-metal cation, an alkaline-earth metal cation, an ammonium cation, a zinc cation, an aluminum cation, a transition-metal cation, an organic cation or any combination thereof. In some embodiments, the active salt is an alkali metal salt, an alkaline earth metal salt, or any combination thereof. The active salt may be, for example, a lithium salt, a sodium salt, a potassium salt, a magnesium salt, a mixture of lithium salts, a mixture of sodium salts, a mixture of potassium salts, a mixture of magnesium salts, and the like. In still further aspects, the active salt used as the first salt is stable towards an anode and cathode of the electrochemical cell. In certain aspects, the first salt can comprise lithium bis(fluorosulfonyl)imide (LiFSI), lithium bis(trifluoromethanesulfonyl)imide (LiTFSI), lithium bis(pentafluoroethanesulfonyl)imide (LiBETI), lithium bis(oxalato) borate (LiBOB), LiPF₆, LiAsF₆, LiBF₄, LiCF₃SO₃, LiClO₄, lithium difluoro oxalato borate anion (LiDFOB), lithium 4,5-dicyano-2-(trifluoromethyl) imidazolide (LiTDI), sodium bis(fluorosulfonyl)imide (NaFSI), sodium bis(trifluoromethylsulfonyl)imide (NaTFSI), sodium bis(pentafluoroethanesulfonyl)imide (NaBETI), NaPF₆, NaAsF₆, NaBF₄, NaCF₃SO₃, NaClO₄, sodium bis(oxalato)borate (NaBOB), sodium difluoro oxalato borate anion (NaDFOB), potassium bis(fluorosulfonyl)imide (KFSI), potassium bis(trifluoromethylsulfonyl)imide (KTFSI), potassium bis(pentafluoroethanesulfonyl)imide (KBETI), KPF₆, KAsF₆, KBF₄, KCF₃SO₃, KClO₄, potassium bis(oxalato) borate (KBOB), potassium difluoro oxalato borate anion (KDFOB), or any combination thereof.

In still further aspects, the second salt can comprise one or more salts. In one aspect, the second salt is different from the first salt. In further aspects, the second salt comprises a cation that is the same or different from a cation of the first salt. In still further aspects, if the second salt is a mixture of salts, at least one salt of the mixture has a cation that is the same as a cation of the first salt. However, also disclosed are aspects where when the second salt is a mixture of salts, none of the salts in the mixture has a cation that is the same as a cation of the first salt. In still further aspects, the second salt comprises LiI, LiBr, LiCl, LiSCN, LiNO₃, LiNO₂, Li₂SO₄, CF₃COOLi, NaI, NaBr, NaCl, NaSCN, NaNO₃, NaNO₂, Na₂SO₄, KI, KBr, KCl, KSCN, KNO₃, KNO₂, K₂SO₄, or any combination thereof. In still further aspects, the second salt does not interact with the first salt.

In still further aspects, the solvent can comprise one or more solvents. In still further aspects, the solvent is a nonaqueous solvent. In aspects where more than one solvent is present, each solvent can be in any ratio to each other that suits the desired application. In still further aspects, the solvent can associate with cations of the first salt (and/or second salt). It is understood that the term “associate,” as used herein, refers to the solvent's capability to solvate or coordinate the first salt (and/or second salt).

In still further aspects, the solvent disclosed herein is a flame retardant solvent. In still further aspects, the flame retardant solvent comprises an organic phosphate, an organic phosphite, an organic phosphonate, an organic phosphoramide, a phosphazene, or any combination thereof. In still further aspects, the flame retardant solvent comprises trimethyl phosphate, triethyl phosphate, tributyl phosphate, triphenyl phosphate, tris(2,2,2-trifluoroethyl) phosphate, bis(2,2,2-trifluoroethyl) methyl phosphate; trimethyl phosphite, triphenyl phosphite, tris(2,2,2-trifluoroethyl) phosphite; dimethyl methylphosphonate, diethyl ethylphosphonate, diethyl phenylphosphonate, bis(2,2,2-trifluoroethyl)methylphosphonate; hexamethylphosphoramide; hexamethoxyphosphazene, hexafluorophosphazene, or any combination thereof.

However, it is understood that the solvent is not limited to the flame retardant solvents and can comprise 1,2-dimethoxyethane (DME), 1,3-dioxolane (DOL), 1,4-dioxane, tetrahydrofuran (THF), allyl ether, diethylene glycol dimethyl ether (or “diglyme”), triethylene glycol dimethyl ether (or “triglyme”), tetraethylene glycol dimethyl ether (or “tetraglyme”), butyl diglyme, dimethyl ether, diethyl ether, polyethylene glycol, acetonitrile, dimethyl sulfoxide, sulfolane, trimethyl phosphate (TMP), triethyl phosphate (TEP), dimethyl methylphosphonate (DMMP), hexamethyldisiloxane, hexamethylcyclotrisiloxane, silanes or any combination thereof.

In still further aspects, the solvent can comprise any mixture of any of the disclosed above solvents.

In still further aspects, the solvation structure of the first salt is dominated by substantially dominated by a plurality of solvent-separated pairs, contact-ion pairs, aggregates or a combination thereof. However, it is understood that in some aspects, the solvation structure of the first salt can also comprise the solvent that is not associated with the first and/or second salt, or in other words, free solvent molecules. In yet still, further aspects, an anion of the second salt forms one or more ionic aggregates.

In still further aspects, the second salt can be considered a diluent. In such aspects, the presence of the second salt allows significant dilution of the first salt (in other words, a decrease in the first salt concentration in the electrolyte) without sacrificing the performance of the electrolyte.

In some aspects, the electrolyte performance is enhanced compared to a substantially identical reference electrolyte without the presence of the second salt as a diluent. In still further aspects, due to the interactions between the first salt, second salt and the solvent, the behavior of the disclosed herein electrolyte corresponds to the electrolytes having a much higher concentration of the first salt in the solvent without the presence of the second salt. In still further aspects, the electrolytes disclosed herein can have the first salt be present in an amount of at least about 20% less, at least about 25% less, at least about 30% less, at least about 40% less, at least about 50% less, at least about 60% less, at least about 70% less, or even at least about 80% less when compared with a substantially identical reference electrolyte in the absence of the second salt.

It is understood that in aspects disclosed herein, the second salt pushes the solvent molecules from the solvation structure of the first salt and thus creating a plurality of solvent-separated pairs, contact-ion pairs, aggregates or a combination thereof while minimizing the presence of the free solvent molecules. In still further aspects, the solvation structure has substantially reduced the amount of free solvent molecules. The solvation structure of the first salt can be determined by Fourier transform infra-red (FTIR) spectroscopy, Raman spectroscopy, and nuclear magnetic resonance (NMR) spectroscopy.

In still further aspects, a molar ratio of the first salt to the solvent can range from about 1:0.5 to about 1:5, including exemplary values of about 1:0.6, about 1:0.7, about 1:0.8, about 1:0.9, about 1:1, about 1:2, about 1:3, and about 1:4.

In still further aspects, the electrolytes disclosed herein can be used in the electrochemical cells. In aspects where the electrochemical cell comprises an anode and/or cathode, the disclosed herein electrolytes are substantially stable towards the anode and/or cathode. In still further aspects, the disclosed herein electrolytes are also substantially stable towards current collectors that can be present in the electrochemical cell. In still further aspects, the disclosed herein electrolytes are also substantially stable towards separators that can be present in the electrochemical cell. It is understood that the term “stable,” as used herein, means that the electrolyte component has negligible chemical and electrochemical reactions with the anode, cathode, separator and current collector.

In still further aspects, when the electrolyte is used in an electrochemical cell, the electrolyte is capable of forming an inorganic-rich interface layer on at least one electrochemically active surface during the operation of the electrochemical cell. In still further aspects, the inorganic-rich interface layer is substantially uniform and substantially compact. It is understood that the term “compact,” as used herein, describes the interface layer as substantially resisting the movement of the electrolyte through this layer to the at least one electrochemical active surface. In still further aspects, the inorganic-rich interface layer formed with the described herein electrolyte is substantially insulating to electrons tunneling while conducive to the ions. In still further aspects, the inorganic-rich interface layer comprises a degradation product of the first salt, the second salt, or a combination thereof. In still further aspects, the inorganic-rich interface layer comprises at least an anion of the first salt, an anion of the second salt, or a combination thereof.

In still further aspects, when the disclosed herein electrolyte is used in the electrochemical cell, such a cell is configured to provide at least about 100, at least about 150, at least about 200, at least about 250, at least about 300, at least about 400, or at least about 500 cycles of stripping/platting.

As disclosed above, the electrochemical cell can comprise at least one electrochemically active surface. In such aspects, the at least one electrochemically active surface is an anode. In other aspects, the at least one electrochemically active surface is a current collector configured to serve as an anode during a plating step. In yet still further aspects, the at least one electrochemically active surface is a cathode.

In still further aspects, the electrochemical cell is a battery.

In still further aspects, disclosed herein is an electrochemical cell comprising: at least one electrochemically active surface; any of the disclosed herein electrolytes; an inorganic-rich interface layer disposed at the at least one electrochemically active surface during an operation of the electrochemical cell; and wherein the electrochemical cell is configured to provide at least about 100, at least about 150, at least about 200, at least about 250, at least about 300, at least about 400, or at least about 500 cycles of stripping/platting.

In still further aspects, the least one electrochemically active surface is an anode surface or a current collector surface configured to behave as an anode during a platting step. In such aspects, the anode or the current collector configured to behave as an anode during a platting step comprises carbon, silicon, tin, antimony, Li, Na, K, Zn, Ni, Cu, Al, silicon, silicon oxides, Mg, Li alloys, Li intermetallics, Li compounds, Na alloys, Na intermetallics, Na compounds, K alloys, K intermetallics, K compounds or any combination thereof.

In still further aspects, the anode can comprise an intercalation material or conversion compound that can be deposited onto a substrate (e.g., a current collector) or can be provided as a free-standing film, typically including one or more binders and/or conductive additives. Suitable binders include, but are not limited to, polyvinyl alcohol, polyvinyl chloride, polyvinyl fluoride, ethylene oxide polymers, polyvinylpyrrolidone, polyurethane, polytetrafluoroethylene, polyvinylidene fluoride, polyethylene, polypropylene, styrene-butadiene rubber, epoxy resin, nylon, and the like. Suitable conductive additives include, but are not limited to, carbon black, acetylene black, Ketjen black, carbon fibers (e.g., vapor-grown carbon fiber), metal powders or fibers (e.g., Cu, Ni, and Al), and conductive polymers (e.g., polyphenylene derivatives). In certain aspects, anode materials can include but are not limited to Mo₆S₈, TiO₂, V₂O₅, Li₄Mn₅O₁₂, Li₄Ti₅O₁₂, C/S composites, graphite/silicon composites, graphite, silicon, and polyacrylonitrile (PAN)-sulfur composites, NaTi₂ (PO₄)₃, TiS₂, CuS, FeS₂, NiCo₂O₄, Cu₂Se, and Li_{0.5}Na_{0.5}Ti₂(PO₄)₃. In certain aspects, the electrochemical cells having the disclosed herein electrolyte can comprise a lithium metal anode, a sodium metal anode, a potassium metal anode, a graphite/silicon composite anode, a graphite anode, or a silicon anode or any other alloying anode.

In aspects where the electrochemical cell comprises the disclosed above anode materials, substantially no dendrites are formed on the anode surface or the current collector during a plating or stripping cycle.

In still further aspects, the at least one electrochemically active surface comprises a cathode. In such aspects, the cathode can be a metal cathode of a composite cathode. In still further aspects, the cathode comprises layered oxide cathodes, vanadium-based cathode, sulfur-based cathodes, manganese-based cathode, rocksalt cathode, disordered rocksalt cathode, lithium-rich cathode, NMC (nickel-manganese-cobalt oxide) cathode, NCA (nickel-cobalt-aluminum oxide) cathode, NFM (nickel-iron-manganese oxide) cathode, LCO (lithium-cobalt oxide) cathode, LFP (lithium iron phosphate) cathode, fluoride-based cathode, sulfur selenium cathode, sulfur cathode, selenium cathode, tellurium cathode, spinels cathode, olivines cathode, or any combination thereof.

In still further aspects, the cathode can comprise Li_{1+w}NiₓMn_{y}Co_{z}O₂ (x+y+z+w=1, 0≤w≤0.25), LiNiₓMn_{y}Co_{z}O₂ (x+y+z=1), LiNi_{0.8}Co_{0.15}Al_{0.05} O₂, LiCoO₂, LiNi_{0.5}Mn_{1.5}O₄ spinel, LiMn₂O₄, LiFePO₄, Li₄₋ₓMₓTi₅O₁₂ (M=Mg, Al, Ba, Sr, or Ta; 0≤x≤1), MnO₂, V₂O₅, V₆O₁₃, LiV₃O₈, LiM^{C1} ₓM^{C2} ₁₋ₓPO₄ (M^{C1} or M^{C2}=Fe, Mn, Ni, Co, Cr, or Ti; 0≤x≤1), Li₃V₂₋ₓM¹ ₓ(PO₄)₃ (M¹=Cr, Co, Fe, Mg, Y, Ti, Nb, or Ce; 0≤x≤1), LiVPO₄F, LiM^{C1} ₓM^{C2} ₁₋ₓO₂ ((M^{C} ₁ and M^{C2} independently are Fe, Mn, Ni, Co, Cr, Ti, Mg, or Al; 0≤x≤1), LiM^{C1} ₓM^{C2} _{y}M^{C3} _{1-x-y}O₂ ((M^{C} ₁, M^{C2}, and M^{C3} independently are Fe, Mn, Ni, Co, Cr, Ti, Mg, or Al; 0≤x≤1; 0≤y≤1), LiMn_{2-y}X_{y}O₄ (X=Cr, Al, or Fe, 0≤y≤1), LiNi_{0.5-y}X_{y}Mn_{1.5}O₄ (X=Fe, Cr, Zn, Al, Mg, Ga, V, or Cu; 0≤y≤0.5), xLi₂MnO₃. (1-x)LiM^{C1} _{y}M^{C2} _{z}M^{C3} _{1-y-z}O₂ (M^{C1}, M^{C2}, and M^{C3} independently are Mn, Ni, Co, Cr, Fe, or mixture thereof; x=0.3-0.5; y≤0.5; z≤0.5), Li₂M²SiO₄ (M²=Mn, Fe, or Co), Li₂M²SO₄ (M²=Mn, Fe, or Co), LiM²SO₄F (M²=Fe, Mn, or Co), Li₂₋ₓ(Fe_{1-y}Mn_{y})P₂O₇ (0≤y≤1), Na_{2/3}Fe_{1/2}Mn_{1/2}O₂, NaNi_{0.3}Fe_{0.4}Mn_{0.3}O₂, Na_{0.76}Mn_{0.5}Ni_{0.3}Fe_{0.1}Mg_{0.1}O₂, NaNi_{1/4}Na_{1/6}Mn_{2/12}Ti_{4/12}Sn_{1/12}O₂, NaNi_{(1-x-y-z)}MnₓMg_{y}Ti_{z}O₂, Na_{0.67}Mn₁₋ₓMgxO₂, Na_{0.67}Mn_{0.95}Mg_{0.05}O₂, Na_{0.67}Ni_{0.3-x}CuₓMn_{0.7}O₂, KFe^{II}Fe^{III}(CN)₆, NaFe^{II}Fe^{III}(CN)₆, Na₃V₂(PO₄)₃, LiFePO₄Cr₃O₈, Cr₂O₅, NaFePO₄, Na₂FePO₄F, Na₂FeP₂O₇, Na₃V₂(PO₄)₃, Na₃V₂(PO₄)₂F₃, NaVPO₄F, NaVPOPOF, Na_{1.5}VOPO₄F_{0.5}, NaCO₂O₄, Na₂Ti₃O₇, and NaₓMO₂ where 0.4≤x≤1, and M is a transition metal or a mixture of transition metals (e.g., NaCrO₂, NaCoO₂, NaₓCoO₂ (0.4≤x≤0.9), Na_{2/3}Ni_{1/3}Mn_{2/3}O₂, Na_{2/3}Fe_{1/2}Mn_{1/2}O₂, Na_{2/3}Ni_{1/6}Co_{1/6}Mn_{2/3}O₂, NaNi_{1/3}Fe_{1/3}Mn_{1/3}O₂, NaNi_{1/3}Fe_{1/3}Co_{1/3}O₂, NaNi_{1/2}Mn_{1/2}O₂, Prussian white analogue cathodes (e.g., Na₂MnFe(CN)₆ and Na₂Fe₂(CN)₆), Prussian blue analogue (PBA) cathodes (Na₂₋ₓMₐ[M_{b}(CN)₆]_{1-y}·nH₂O, wherein M^{a} and M^{b} independently are Fe, Co, Ni, or Cu, x=0 to 0.2, y=0 to 0.2, n=1 to 10). Other sodium intercalation materials include Na₄Ti₅O₁₂, Fe₃O₄, TiO₂, Sb₂O₄, Sb/C composite, SnSb/C composite, BiSb/C composite, and amorphous P/C composite. In an independent embodiment, the cathode is a sodium conversion compound in which sodium displaces another cation, such as FeSe, CuWO₄, CuS, CuO, CuCl, or CuCl₂, zirconium disulfide, cobalt (II, III) oxide, tungsten selenide, V₂O₅, molybdenum-vanadium oxide, stainless steel, Mo₆S₈, Mg₂Mo₆S₈, MoS₂, Mo₆S_{8-y}Se_{y} where y=0, 1, or 2, MgₓS₃O₄ where 0<x<1, MgCoSiO₄, MgFeSiO₄, MgMnSiO₄, V₂O₅, WSe₂, sulfur, poly(2,2,6,6-tetramethylpiperidinyloxy-4-yl methacrylate)/graphene, MnO₂/acetylene black, and carbyne polysulfidea carbon/sulfur composite, or an air electrode.

In still further aspects, the electrochemical cells using the disclosed herein electrolytes and cathodes exhibit a surface of the cathode that is substantially free of cracks during the cell operation.

In still further aspects, the electrochemical cells described herein can comprise current collectors. In such aspects, the current collectors can be a metal or another conductive material, such as (but not limited to) nickel (Ni), copper (Cu), aluminum (Al), iron (Fe), stainless steel, or conductive carbon materials. The current collector may be a foil, a foam, or a polymer substrate coated with a conductive material.

In still further aspects, the electrochemical cell is a battery comprising two electrochemically active surfaces comprising an anode and a cathode. In still further aspects, the battery can comprise a separator. In such aspects, any known in the art separators that are capable of achieving the desired results can be used. For example, and without limitations, the separators can comprise glass fiber, a porous polymer film (e.g., polyethylene- or polypropylene-based material) with or without a ceramic coating, or a composite (e.g., a porous film of inorganic particles and a binder). One exemplary polymeric separator is a polyethylene (PE) membrane. Another exemplary polymeric separator is a polypropylene (PP) membrane. Another exemplary polymeric separator is a Celgard® 3501 surfactant-coated polypropylene membrane. The separator may be infused with an electrolyte, as disclosed herein.

In still further aspects, the batteries disclosed herein are secondary batteries.

In one unlimited example, the electrochemical cell disclosed herein can comprise an electrolyte comprising: the first salt comprising NaFSI; the second salt comprising NaNO₃; the solvent comprising trimethyl phosphate; the anode comprises a sodium metal or a sodium ion; and the cathode comprises sodium nickel-iron-manganese oxide.

In still further aspects, the batteries disclosed herein can exhibit a Coulombic efficiency greater than about 80%, greater than about 85%, greater than about 90%, greater than about 95%, or greater than about 99% over at least about 500 cycles. It is understood that such a Coulombic efficiency can also be observed for at least about 700 cycles, at least about 1,000 cycles, at least about 5,000 cycles, at least about 10,000 cycles, or at least about 20,000 cycles.

In yet still further aspects, the battery exhibits a capacity retention of at least about 75%, at least about 80%, at least about 85%, at least about 90%, at least about 95%, at least about 99%, over at least about 500 cycles. It is understood that such capacity retention can also be observed for at least about 700 cycles, at least about 1,000 cycles, at least about 5,000 cycles, at least about 10,000 cycles, or at least about 20,000 cycles.

In still further aspects, a battery including the disclosed herein electrolyte exhibits a performance at least equal to, or even superior to, a comparison battery including a superconcentrated electrolyte comprising a higher than disclosed herein concentration of the first salt and the solvent but without the presence of the second salt. In such aspects, the coulombic efficiency of the disclosed electrochemical cell can be at least about 2% higher, at least about 5% higher, at least about 10% higher, at least about 20% higher, at least about 30% higher, or at least about 50% higher than the coulombic efficiency of a substantially identical reference electrochemical cell having a substantially identical anode and cathode materials, substantially identical electrolyte having the same or higher concentration of the first salt, the solvent but in the absence of the second salt.

In still further aspects, the electrochemical cell disclosed herein is capable of operating in a temperature range from about −30° C. to about 60° C., including exemplary values of about −25° C., about −20° C., about −15° C., about −10° C., about −5° C., 0° C., about 5° C., about 10° C., about 15° C., about 20° C., about 25° C., about 30° C., about 35° C., about 40° C., about 45° C., about 50° C., and about 55° C.

By way of example, electrochemical cells of the present disclosure may be used in portable batteries, including those in hand-held and/or wearable electronic devices, such as a phone, watch, or laptop computer; in stationary electronic devices, such as a desktop or mainframe computer; in an electric tool, such as a power drill; in an electric or hybrid land, water, or air-based vehicle, such as a boat, submarine, bus, train, truck, car, motorcycle, moped, powered bicycle, airplane, drone, other flying vehicle, or toy versions thereof; for other toys; for energy storage, such as in storing electric power from wind, solar, wave, hydropower, or nuclear energy and/or in grid storage, or as a stationary power store for small-scale use, such as for a home, business, or hospital.

In addition, batteries, according to the present disclosure, may be multi-cell batteries containing at least about 10, at least about 100, at least about 500, between 10 and 10,000, between 100 and 10,000, between 1,000 and 10,000, between 10 and 1000, between 100 and 1,000, or between 500 and 1,000 electrochemical cells of the present disclosure. Cells in multi-cell batteries may be arranged in parallel or in series.

Also disclosed herein are the methods of making the disclosed electrolytes and electrochemical cells comprising the same.

By way of a non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

### Methods

Preparation of the electrolytes. Sodium bis(fluorosulfonyl)imide (NaFSI, Solvionic Corporation) was dried in a vacuum oven for 24 h at 50° C. Trimethyl phosphate (TMP, Sigma-Aldrich), propylene carbonate (PC, Sigma-Aldrich), and fluoroethylene carbonate (FEC, Sigma-Aldrich) were dried with molecule sieves for 3 days. All the electrolytes were prepared inside an Ar-filled glove box. NaFSI—NaNO₃-TMP electrolyte was prepared by dissolving 1.1 M NaFSI and 0.3 M NaNO₃ in TMP and stirring over 3 h to obtain transparent solutions. The carbonate-based electrolyte solution was 1.0 M NaClO₄ in PC with 3 wt. % FEC. The LHCE was prepared as previously reported.

Preparation of the Na(Ni_{0.3}Fe_{0.4}Mn_{0.3})O₂ cathode. O3-Na(Ni_{0.3}Fe_{0.4}Mn_{0.3})O₂ was synthesized by calcining the coprecipitated Ni_{0.3}Fe_{0.4}Mn_{0.3}(OH)₂ precursor with NaOH at 900° C. for 20 h, as previously described. The cathode was prepared by mixing the active material, Super P conductive carbon, and poly(vinylidene) fluoride (PVDF) at a weight ratio of 8:1:1. The mixture was then dispersed in N-methyl-2-pyrolidone (NMP) and stirred to form a uniform slurry. The obtained slurry was cast onto an Al foil with an active-material loading of ˜5, ˜11.3, and ˜12.5 mg cm⁻², followed by drying in a vacuum oven.

Characterizations. The morphology investigation was performed with a scanning electron microscope (FEI Quanta 650 SEM) operated at 20 kV. XPS analysis was performed with a Kratos Analytical spectrometer at room temperature with monochromatic Al Kα (1,486.6 eV) radiation. The ionic conductivities of the electrolytes at 25° C. were measured with a SevenCompact™ S230 Conductivity Benchtop Meter. FTIR spectroscopy was conducted in the attenuated totaled reflectance (ATR) configuration and was performed on a Thermo Scientific-Nicolet iS5 FTIR spectrometer. NMR spectroscopy was performed via a Bruker Avance III 500 MHz NMR spectrometer. For NMR sample preparation, 700 μL of each sample was diluted with 100 μL of D6-acetone as an external standard. 31P NMR was performed with pulse deconvolution.

Synchrotron X-ray diffraction (XRD). Synchrotron-based operando energy dispersive X-ray diffraction (ED-XRD) measurements were conducted with beamline 6BM-A at the Advanced Photon Sources in Argonne National Laboratory. The white X-ray radiation was generated by bending magnets with an energy range of 20-200 keV. The detection angles were 2.477° for the Canberra germanium detector to collect the diffraction pattern. The operando experiment was conducted with a transmission geometry and provided spatial and temporal mapping capabilities. Coin cells were cycled at C/10 within 2.0 to 4.0 V, during which the ED-XRD pattern was collected for 60 s at one point. The height (10 μm) and width (2 mm) of the incident X-ray beam were kept constant during the measurement. Two points at different amplitudes, corresponding to different locations to the separator, were measured continuously until the cells went through one full cycle. The measured intensities of the two data points were added up to improve the signal-to-noise ratio. Rietveld refinement was not applied to calculate the crystalline lattice parameters because of the limited detectable Q range and different X-ray energies during measurement. Instead, the peak positions of the (101) peak and (003) peak were identified and used to calculate the evolution of the crystalline lattice parameters. It is worth noting that the accuracy of the fitted lattice parameters was affected by the broadening of these two peaks and the signal-to-noise ratio.

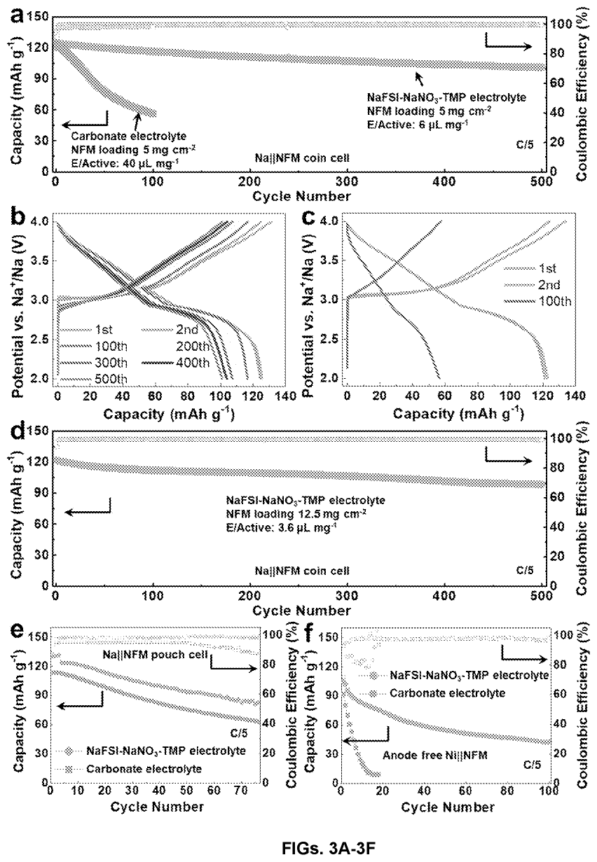

Electrochemical measurements. Coin-type (CR2032) cells were assembled inside an Ar-filled glove box with sodium metal as the anode. Celgard 2500 was used as the separator for the NaFSI—NaNO₃-TMP electrolytes. Glass fiber was used as the separator for the carbonate-based electrolytes. The electrolytes were prepared as in the abovementioned procedures. The thicknesses of the Na foil in FIG. 3A in carbonate electrolyte and NaFSI—NaNO₃-TMP electrolytes are, respectively, 900 and 340 μm. The Na foil used for high-loading, lean electrolyte studies is 40 μm in thickness rolled on to a 12 μm Cu foil, as shown in FIG. 24. The monolayer dimension of the pouch cell is 4.78 cm×8.15 cm, and the cycling pressure is 35 psi. An Arbin battery cycle was used to conduct the cycling test between 2 and 4 V with a current rate of C/5, assuming a 120 mA h g⁻¹ capacity, at room temperature.

Theoretical Calculations. The solvation models were simulated via ab initio molecular dynamic (AIMD) calculations using the Vienna ab initio simulation Package (VASP). Generalized gradient approximation (GGA) with Perdew-Burke-Ernzerhof (PBE) 38 exchange-correlation functional was used in conjunction with the projector augmented wave (PAW) pseudopotentials. Initial geometries of solutions were generated by Packmol software that allows the random mixing of salt and solvent molecules. The virtual box size and the number of salt/solvents were decided by reflecting the experimental density of each electrolyte. The number of atoms, volume of a virtual cell, and temperature at 373 K (NVT) were maintained during the calculation. An energy cutoff of 600 eV with a Monhrost-Pack reciprocal space grid of 1×1×1 k-points scheme was used.

### Example 1

In this disclosure, the concept of utilizing a salt as a diluent to greatly reduce the amount of expensive sodium bis(fluorosulfonylimide) (NaFSI) and fluoroether-based diluents required in LHCEs was introduced. By using sodium nitrate (NaNO₃) salt as a model diluent, a non-flammable, cost-effective 1.1 M NaFSI and 0.3 M NaNO₃ in trimethyl phosphate (TMP) electrolytes are reported. The low concentration of NaFSI and NaNO₃ significantly reduces the amount of salt required to form the LHCE, reducing the cost of the electrolyte (Table 1). The TMP-based LHCE can form a compact, uniform salt-derived electrode-electrolyte interface layer. The formation of an inorganic-rich interface on the anode greatly improves Na-metal stability, displaying a long lifespan of 2,500 h in a Na∥Na symmetric cell. The TMP-based LHCE also enables Na∥NFM cells with an NFM loading of 12.5 mg cm⁻² to achieve a high Coulombic efficiency (CE) of 99.3% and a high capacity retention of 80% over 500 cycles.

TABLE 1
Price and supplier information of the
NaFSI salt and NaNO₃ and TTE diluents

| Chemical | Price | Supplier |
|---|---|---|
| TTE | $115 for 100 g | Synquest Laboratories |
| NaNO₃ | $65 for 1000 g | Alfa Aesar |
| NaFSI | $595.80 for 50 g | Solvionic |

### Tailoring the Electrolyte Formulation

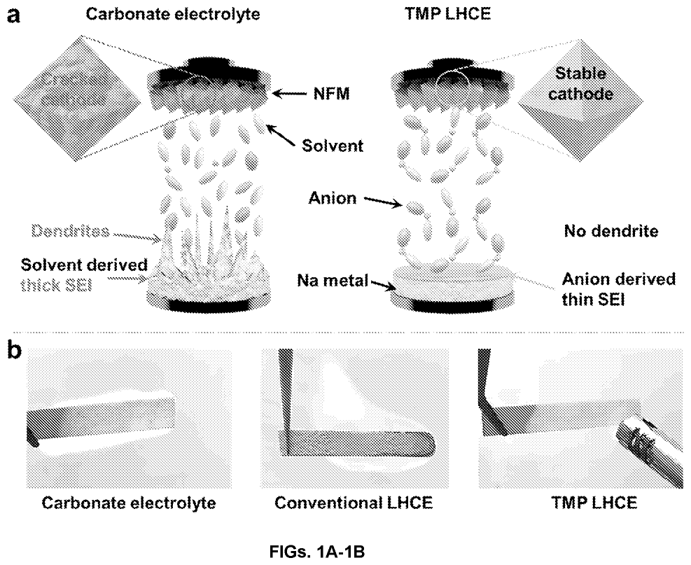

A common electrolyte for SMBs is 1.0 M NaClO₄ in propylene carbonate (PC) with 3 wt. % fluoroethylene carbonate (FEC) as an additive. As mentioned above, owing to the presence of free solvent molecules, there is an incessant reaction of the carbonate-based with NFM and Na metal, resulting in severe NFM cracking and uncontrollable dendritic sodium growth, as illustrated in FIG. 1A (left). This renders them unsuitable for the long-term stability of SMBs. In the TMP-based LHCE, like the NaFSI salt, the eutectic NaNO₃ diluent molecule strongly interacts with TMP. It subtly replaces the TMP site in the Na-ion primary solvation shell. This solvation structure facilities the construction of a compact SEI on both the anode and cathode derived from the decomposition of the electrolyte salts. Without wishing to be bound by any theory, it is hypothesized that such an electrolyte design would therefore enable long-life SMBs.

In addition, the use of a single non-flammable solvent like TMP also improves the safety of the cells. The flammability of the electrolyte plays a critical role in the thermal stability of cells. The flame test reveals the non-flammability of NaFSI—NaNO₃-TMP electrolyte, as shown in FIG. 1B. TMP acts as an effective fire extinguisher, scavenging the active hydrogen radicals and preventing the combustion chain reaction, so the NaFSI—NaNO₃-TMP electrolyte shows impressive non-flammability. To clearly demonstrate the outstanding non-flammability of NaFSI—NaNO₃-TMP electrolyte, a commonly used LHCE with TTE as a diluent was reported previously. By contrast, the carbonate electrolyte and conventional LHCE easily catch fire.

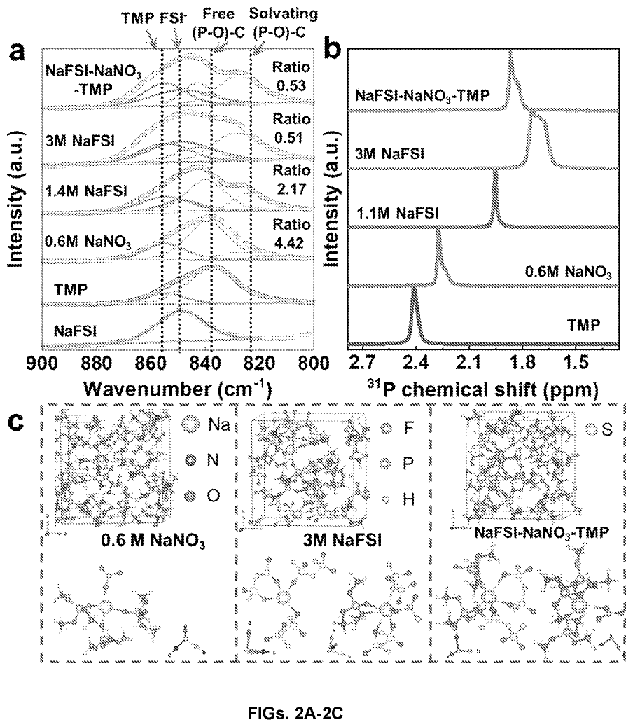

Here, first, the solvation structure of NaFSI—NaNO₃-TMP electrolyte was determined through Fourier transform infrared (FTIR) spectroscopy. Looking at the FTIR spectrum in the 900-800 cm⁻¹ region, the major peak at 837 cm⁻¹ and the minor peak at 856 cm⁻¹ corresponds to the (P—O)—C vibration of the different conformers of the phosphate functional group. When the salt is dissolved in TMP, it coordinates with the P═O bond, causing the (P—O)—C vibration to shift to 828 cm⁻¹, which is indicated as solvated phosphate. The ratio between uncoordinated and coordinated (solvating) TMP is indicated in FIG. 2A. In pure TMP, 0.6 M NaNO₃ in TMP, and 1.4 M NaFSI in TMP, a high ratio of TMP indicated the presence of free unhindered TMP. Despite having a lower concentration of NaFSI (1.1 M) in NaFSI—NaNO₃-TMP, its solvation structure resembles a 3 M solution. The NaFSI—NaNO₃-TMP keeps the solvation structure and provides a high ionic conductivity of 5.99×10⁻³ S cm⁻¹, which is higher than that of other electrolytes with similar compositions, as shown in Table 2.

Nuclear magnetic resonance (NMR) was further conducted to confirm the solvation structure of the developed electrolyte (FIG. 2B). In ³¹P-NMR, the peak at 2.4 ppm corresponds to the P in the phosphate group. As TMP primarily coordinates through the P═O bond, the electron-donating nature of the CH₃—O—P linkage leads to an upfield shift of the P peak to 2.28 ppm. The presence of a shoulder at 2.25 ppm suggests the presence of conformers of TMP presented in the solvation shell. It could also indicate the solvation through the CH₃—O—P bonds. A further upfield shift is observed in the concentrated electrolyte. The presence of multiple peaks denotes the formation of CIPs and AGGs with multiple P—O bonds assisting in solvation.

To corroborate the solvation structure observed in the FTIR and NMR study, ab-initio molecular dynamics (AIMD) study was performed to determine the solvation sheath formed in these electrolyte solutions, as shown in FIG. 2C. In agreement with FTIR and NMR data, NaNO₃ is primarily solvated by TMP. In the HCE consisting of 3 M NaFSI in TMP, the solvation structure is dominated by CIPs and AGGs, with TMP being replaced by NaFSI pairs. In the NaFSI—NaNO₃-TMP LHCE, NaNO₃ can nudge the TMP out of the primary solvation structure. Therefore, AGGs with NO₃⁻ are formed, making the solvation structure resemble HCE than the dilute electrolyte. Table 3 lists the LUMO/HOMO levels of the three components. TMP has the highest LUMO, indicating that it has the best cathodic stability compared to FSI⁻ and NO₃⁻. Thus, NO₃⁻ and FSI⁻ anions are preferentially decomposed when participating in a solvation structure.

TABLE 2
Measured ionic conductivity (σ) of the electrolytes at 25° C.

| Electrolyte | σ at 25° C. (S cm⁻¹) |
|---|---|
| NaFSI—NaNO₃-TMP | 5.99 × 10⁻³ |
| 3M NaFSI in TMP | 2.25 × 10⁻³ |
| 0.3M NaNO₃-TMP | 1.53 × 10⁻³ |
| LHCE in DME/TTE | 1.98 × 10⁻³ |
| Carbonate electrolyte | 1.35 × 10⁻³ |

TABLE 3
LUMO/HOMO levels of three components

| | TMP | FSI⁻ | NO₃⁻ |
|---|---|---|---|
| LUMO (eV) | −0.109 | −1.813 | −3.045 |
| HOMO (eV) | −8.382 | −9.866 | −10.374 |

### Example 2

### Electrochemical Performance of Sodium-Metal Batteries

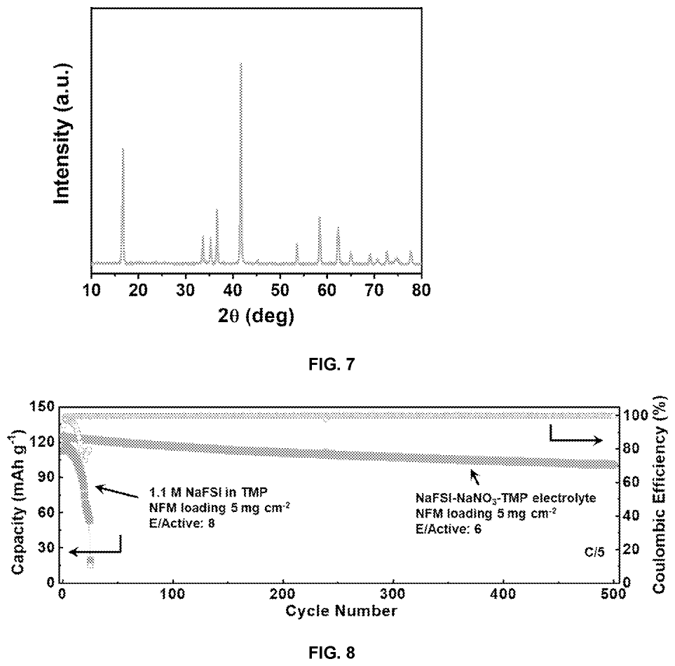

To demonstrate the advantages of the NaFSI—NaNO₃-TMP electrolyte in a battery, the electrochemical performance of Na(Ni_{0.3}Fe_{0.4}Mn_{0.3})O₂ (NFM) in a Na∥NFM cell with various electrolytes was tested. The XRD pattern in FIG. 7 confirms the R3̅m layered structure of the NFM material. As shown in FIG. 3A, the NFM in carbonate electrolyte exhibits poor cycling stability with a low capacity retention of 46% and low Coulombic efficiency (CE) of 98% after 100 cycles, owing to the complex multiphase evolution in the bulk structure and continuous degradation of the electrolyte-cathode interface. Importantly, because the carbonate electrolyte is not well compatible with the polypropylene separator, flooded electrolyte is required to wet both the cathode and anode, corresponding to a high electrolyte-to-active material (E/Active) ratio of 40 μL mg⁻¹. Such high E/Active will greatly reduce the energy density of the cell, which further hampers the practical viability of SMBs.

The cell with NaFSI—NaNO₃-TMP electrolyte delivers a high initial capacity of 126 mA h g⁻¹. It shows a significant improvement in cycling stability with a high capacity retention of 80% over 500 cycles at a low rate of C/5, which corresponds to a running time of over a half year.

Meanwhile, the Coulombic efficiency after 500 cycles still reaches 99.8% at the low rate of C/5. Without wishing to be bound by any theory, these results suggest suppression of the side reactions between the NaFSI—NaNO₃-TMP electrolyte and the electrodes upon cycling. The E/Active in the cell with NaFSI—NaNO₃-TMP electrolyte can be controlled to be 6 μL mg⁻¹. As shown in FIG. 3B, the voltage-capacity profile of NFM in NaFSI—NaNO₃-TMP electrolyte shows a slight decrease in capacity and an increase in overpotential over 500 cycles. By contrast, the NFM in carbonate electrolyte shows a dramatic capacity decay and increase in overpotential even only after 100 cycles (FIG. 3C).

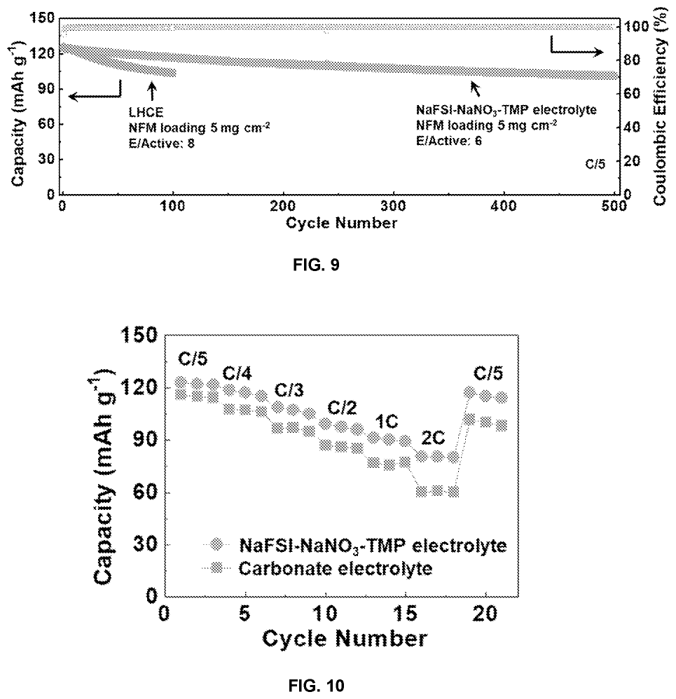

To demonstrate the role of NaNO₃ in the disclosed electrolyte, a dilute electrolyte of 1.1 M NaFSI in TMP electrolyte was prepared. As shown in FIG. 8, the Na∥NFM cell with 1.1 M NaFSI in TMP electrolyte can work only for about 25 cycles, followed by a dramatic capacity fade. FIG. 9 further compares the performances of state-of-the-art LHCE with the developed electrolyte. The result shows that the NaFSI—NaNO₃-TMP electrolyte still outperforms the state-of-the-art LHCE, highlighting the advantages of the NaFSI—NaNO₃-TMP electrolyte to stabilize both the Na anode and the NFM cathode.

To further illustrate the practical viability of NaFSI—NaNO₃-TMP electrolyte, the cell was tested under realistic conditions with a high NFM active mass loading of 12.5 mg cm⁻² and a low electrolyte/active material (E/Active) ratio of 3.6 μL mg⁻¹ and a negative to positive electrode capacity (N/P) ratio of 3.8. As shown in FIG. 3D, the cycling performance of the cell with high NFM loading and low electrolyte almost remains as good as that with low NFM loading, indicating an excellent wettability of the electrodes with the electrolyte. The rate performance of the Na∥NFM cell with NaFSI—NaNO₃-TMP electrolyte was also investigated, as shown in FIG. 10. Even at a high current density of 2 C, the Na∥NFM cell with the NaFSI—NaNO₃-TMP electrolyte can still deliver 86 mA h g⁻¹, which further confirms the fast redox kinetics in the Na∥NFM cell with NaFSI—NaNO₃-TMP electrolyte.

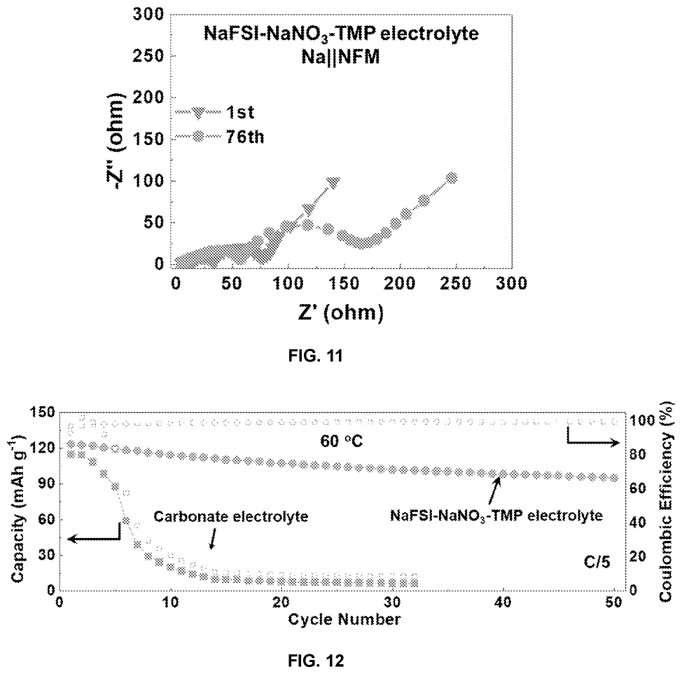

The performance of NaFSI—NaNO₃-TMP electrolyte in pouch cells was further investigated. As shown in FIG. 3E, the pouch cell with carbonate electrolyte with an NFM loading of 11.3 mg cm⁻² exhibits a low capacity of 63 mA h g⁻¹ and poor cycling performance with a low CE of 87% after 76 cycles. In stark contrast, the cell with the NaFSI—NaNO₃-TMP electrolyte with an NFM loading of 12.5 mg cm⁻² shows a capacity of 82 mA h g⁻¹ and a CE of 98% after 76 cycles, which are much higher than those with carbonate electrolyte. It should be noted that the capacity of the pouch cell with NaFSI—NaNO₃-TMP electrolyte shows a faster decay compared to the coin cell counterpart, which may be attributed to the increased inhomogeneous reaction in the large-size electrode that can lead to an increase in impedance. This is further revealed by the EIS spectra of the Na∥NFM pouch cell in the NaFSI—NaNO₃-TMP electrolyte in FIG. 11. The Na∥NFM pouch cell in NaFSI—NaNO₃-TMP electrolyte after 76 cycles shows a significantly increased impedance compared to that after 1st cycle.

Notably, the cycling performance of the pouch cell with NaFSI—NaNO₃-TMP electrolyte was obtained under a low electrolyte amount (E/Active: 2.5 μL mg⁻¹, N/P: 3.8) compared to that with carbonate electrolyte (E/Active: 10 μL mg⁻¹; N/P: 4.2). Owing to the good compatibility of NaFSI—NaNO₃-TMP electrolyte with the polypropylene separator, the lean electrolyte could wet well the cathode and anode.

To further demonstrate the outstanding properties of NaFSI—NaNO₃-TMP electrolyte, an anode-free cell was constructed with an NFM cathode and Ni foil serving as the anode current collector for Na deposition. As shown in FIG. 3F, the Ni∥NFM cell with NaFSI—NaNO₃-TMP electrolyte can still deliver an initial discharge capacity of 104 mA h g⁻¹, which is very close to that of the Na∥NFM cell paired with a Na-foil, suggesting an efficient deposition of Na in an anode-free Ni∥NFM cell. The Ni∥NFM anode-free cell with NaFSI—NaNO₃-TMP electrolyte maintains 43 mA h g⁻¹ over 100 cycles, demonstrating reduced irreversible products on the Na surface, which results in a greatly improved utilization of Na in the anode-free Ni∥NFM cell. In sharp contrast, the anode-free Ni∥NFM cell with carbonate electrolyte quickly stops working after 10 cycles with a capacity of only 20 mA h g⁻¹. The results demonstrate the outstanding capability of NaFSI—NaNO₃-TMP electrolyte for Na anode protection.

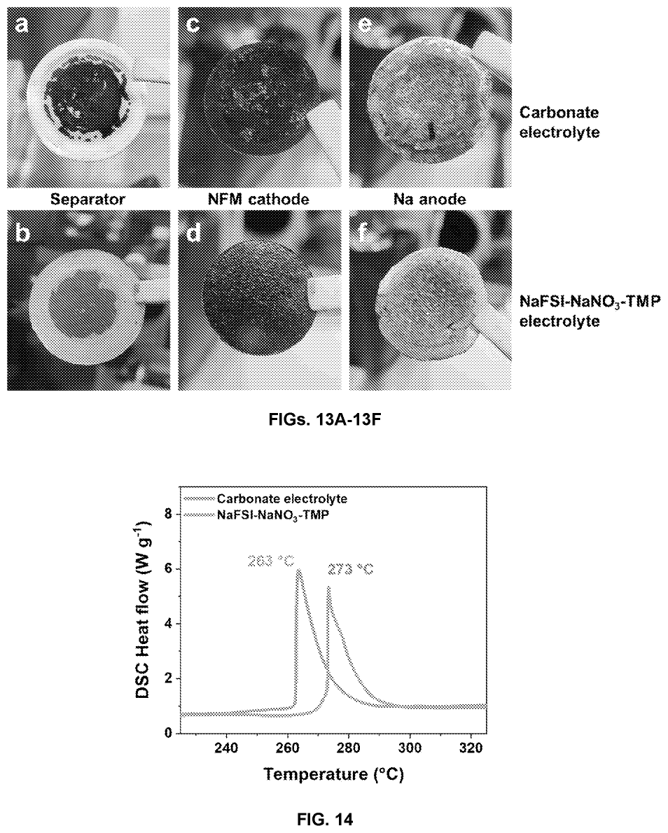

To confirm the stability of the NaFSI—NaNO₃-TMP electrolyte, the Na∥NFM cells were tested at 60° C. As shown in FIG. 12, the cell with NaFSI—NaNO₃-TMP electrolyte shows much more stable cycling performance at 60° C. than the cell tested in the baseline carbonate electrolyte. In addition, the cycled cells with carbonate electrolyte and NaFSI—NaNO₃-TMP electrolyte at 60° C. were disassembled, and the photographs of the separators, NFM cathodes, and Na-metal anodes of the cycled cells with carbonate electrolyte or NaFSI—NaNO₃-TMP electrolyte at 60° C. are shown in FIGS. 13A-13F. The separator in the cell with carbonate electrolyte has several black regions, indicating minor burning after an internal short-circuit. The unstable interfaces could cause this at both the anode and the cathode. Such an unstable interface on the cathode and anode can be reconfirmed by the uneven NFM cathode and Na anode. In sharp contrast, the separator, NFM cathode, and Na anode extracted from the cells with NaFSI—NaNO₃-TMP electrolyte show only a slight change demonstrating the excellent high-temperature operational safety of the cell with NaFSI—NaNO₃-TMP electrolyte. Differential scanning calorimetry (DSC) was employed to investigate the cathode's thermal stability in the two different electrolytes. A mixture of electrolyte and charged cathode powder were continually heated, and the heat release was measured. As shown in FIG. 14, the onset temperature of the thermal runway for charged NFM in the NaFSI—NaNO₃-TMP electrolyte is around 10° C. higher than that in the carbonate electrolyte, corresponding to an increase from 263 to 273° C.

### Stable Cathode-Electrolyte Interface in NaFSI—NaNO₃-TMP Electrolyte

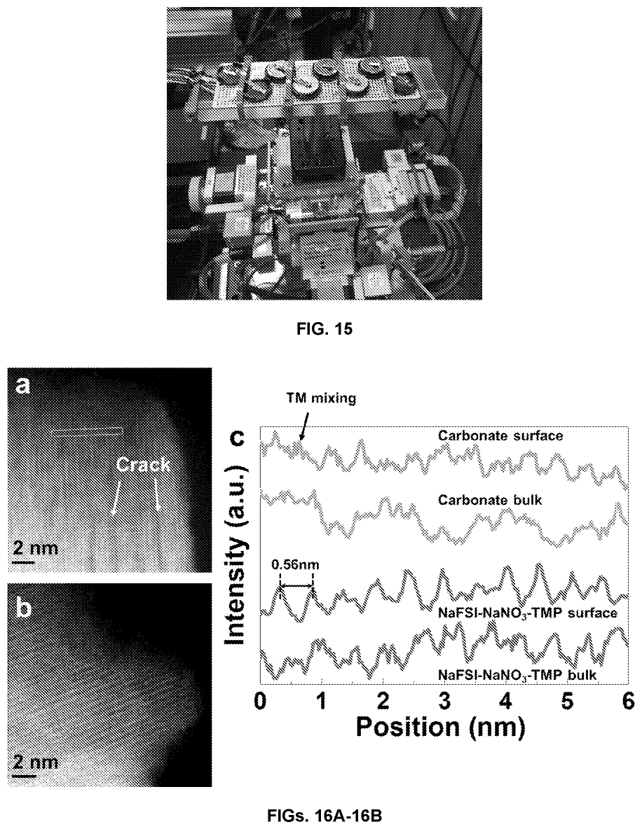

Synchrotron-based operando energy dispersive X-ray diffraction (ED-XRD) was conducted to experimentally assess the Na(Ni_{0.3}Fe_{0.4}Mn_{0.3})O₂ (NFM) phase transitions in different electrolytes. Unlike most of the operando X-ray scattering experiments for battery studies that require a window coin cell setup, the ultrahigh-energy of the X-ray (up to 200 keV) at the sector 6BM-A of the Advanced Photo Source in Argonne National Laboratory provides a deep penetration depth, and thus normal coin cells (CR2032) could be used for the measurement (FIG. 15). Therefore, the electrochemical performance of the measured materials during the operando measurement can accurately present their actual behavior.

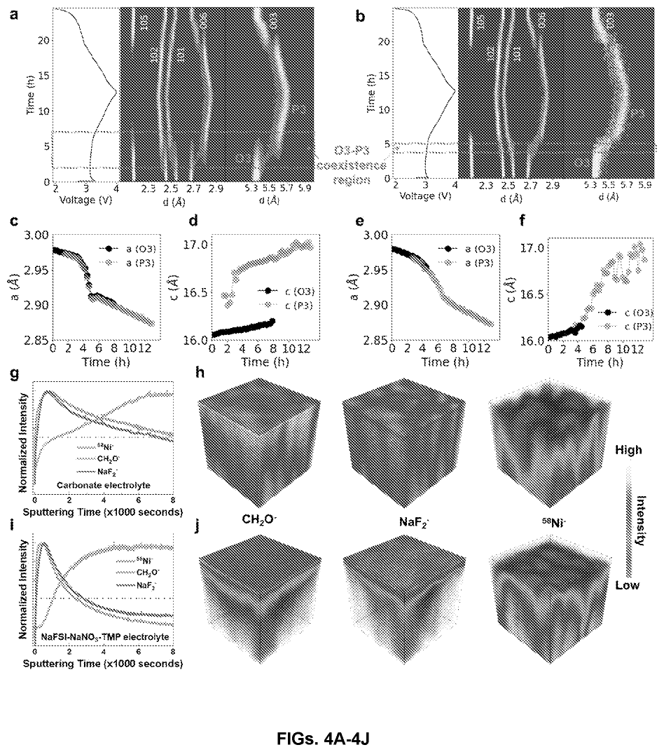

The evolution of the NFM crystalline lattice parameter was obtained during a full cycle in carbonate electrolyte (FIGS. 4A, 4C, and 4D) and NaFSI—NaNO₃-TMP electrolyte (FIGS. 4B, 4E, and 4F). The cells were cycled from 2.0 to 4.0 V at a 0.1 C rate, during which the XRD pattern was continuously recorded, as indicated by the contour plot next to the electrochemical curve in FIGS. 4A-4B. A few major peaks of the NFM are labeled, including (105), (102), (101), (006), and (003) reflections. It has been reported that the NFM material goes through O3 to P3 phase transition when charged from 2.0 to 4.0 V. FIGS. 4A and 4B suggest that the NFM materials in both cells transformed from O3 to P3 when charged to 4.0 V and could reversibly transform back to the 03 phase when discharged to 2.0 V. However, the phase transition process was quite different in the two cells.

FIG. 4A shows a larger region of the O3-P3 two-phase coexistence, as indicated by the red rectangular box. The coexistence of the O3 and P3 phases could be from the reaction heterogeneity within the cathode due to the poor kinetics. Some proportion of the NFM material leads the reaction, while some lag during charging. FIGS. 4C-4D show the evolution of the NFM lattice parameters during the charging process in the carbonate electrolyte. The O3-P3 coexistence region lasted from the second hour to the eighth hour during charging. By comparison, the O3-P3 two-phase coexistence region during charging is much smaller when tested in the NaFSI—NaNO₃-TMP electrolyte (FIG. 4B). FIGS. 4E-4F suggest that the region lasted from the third hour to the fifth hour during charging. The smaller two-phase coexistence region indicates a short period for all the NFM materials being reacted and transformed to the P3 phase, suggesting faster reaction kinetics in the NaFSI—NaNO₃-TMP electrolyte. The heterogeneity in carbonate electrolyte can potentially lead to a large local current density, large strain and stress, particle cracking, and many other side effects that could accelerate the degradation of the NFM cathode. In addition to a shorter dual-phase region with the NaFSI—NaNO₃-TMP electrolyte, the lattice parameters also have a more continuous, smoother transition (FIGS. 4E-4F) than those in the carbonate electrolyte (FIGS. 4C-4D). The smoother lattice parameter evolution may be the result of the reduced local current density within the material.

Such a large strain and stress in the sample with carbonate electrolyte is further revealed by the TEM images of the cycled NFM. As shown in FIG. 16A, many huge cracks can be easily observed in the TEM images of the cycled NFM with carbonate electrolyte. By contrast, the cycled NFM with NaFSI—NaNO₃-TMP electrolyte remains intact, as indicated by the TEM images in FIG. 16B. As suggested by the additional peak between the transition-metal planes in FIG. 16C, the mixing on the surface of the cathode in the NaFSI—NaNO₃-TMP electrolyte is less severe than that on both the surface and bulk of the cathode in the carbonate electrolyte. This deterioration of the layered structure on the surface and the bulk in the carbonate electrolyte further reveals the cell's kinetic and thermodynamic differences. The kinetics are reduced owing to slowed sodium-ion diffusion caused by blocked sodium channels and the hindrance of the O3-to-P3 phase transition caused by cation mixing.

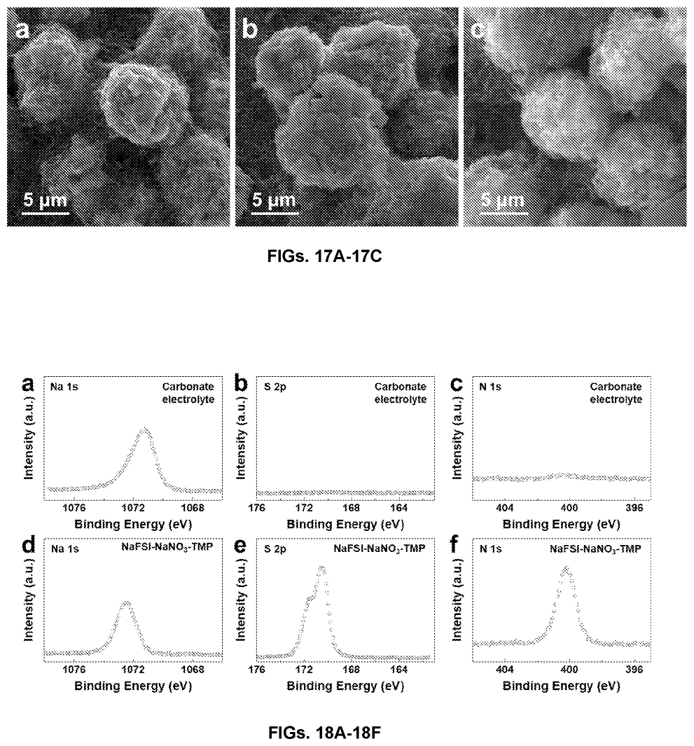

The SEM images indicate good integrity of the cycled NFM with the NaFSI—NaNO₃-TMP electrolyte in FIGS. 17A-17C.

To investigate the interface composition formed on the surface of the NFM, time-of-flight secondary-ion mass spectrometry (TOF-SIMS) depth profiling was employed, which is a powerful technique to identify the detailed chemical composition of the solid surface along with its depth. The TOF-SIMS depth profiles (normalized to their maximum) of the surface of the NFM cathodes in carbonate electrolyte (FIG. 4G) or NaFSI—NaNO₃-TMP electrolyte (FIG. 4I) after 50 cycles were obtained, which reveal the depth distribution of various species in the CEI. As shown in the depth profiles, the inorganic component (NaF₂⁻) and an organic component (CH₂O⁻) are interspersed without segregation and comprise the bulk of the CEI in both electrolytes. Here, the ⁵⁸Ni-species were selected as a representative of NFM. It is noteworthy that the thickness of the CEI in the NaFSI—NaNO₃-TMP electrolyte is only one-third of that in the carbonate electrolyte, according to the full-width-at-half-maximum (FWHM) of the normalized profiles of the CEI species. To clearly illustrate the difference in the thickness between the CEIs formed in carbonate electrolyte and NaFSI—NaNO₃-TMP electrolyte, the 3D visualization of the architecture evolution of the cycled NFM is presented in FIG. 4H (carbonate electrolyte) and FIG. 4J (NaFSI—NaNO₃-TMP electrolyte). From FIG. 4H, it can be observed that the acidic species have severely corrupted the NFM surface in the carbonate electrolyte. Such corrosion and electrolyte salt and solvent decomposition are the main sources of the CEI. As shown in FIG. 4H, both the CH₂O⁻ and the NaF₂⁻ show strong intensity over the whole investigated depth. In contrast, the CEI formed in the NaFSI—NaNO₃-TMP electrolyte has less CH₂O⁻ and NaF₂⁻ than the carbonate electrolyte. More importantly, a compact and uniform CEI layer can be clearly detected on the NFM in NaFSI—NaNO₃-TMP electrolyte, which can be easily reflected by the segregation between the CH₂O⁻ or NaF₂⁻ and ⁵⁸Ni⁻. It is noteworthy that the intensity of NaF₂⁻ derived from salt decomposition is stronger than that of CH₂O⁻ originating from solvent decomposition. This result indicates that the inorganic derived anions form a robust passivation film, realizing a reversible electrode reaction on NFM. The XPS results in FIGS. 18A-18F further demonstrate the formation of inorganic-rich CEI on NFM in NaFSI—NaNO₃-TMP electrolyte.

### Long Cycle Life, Dendrite-Free Sodium-Metal Anode

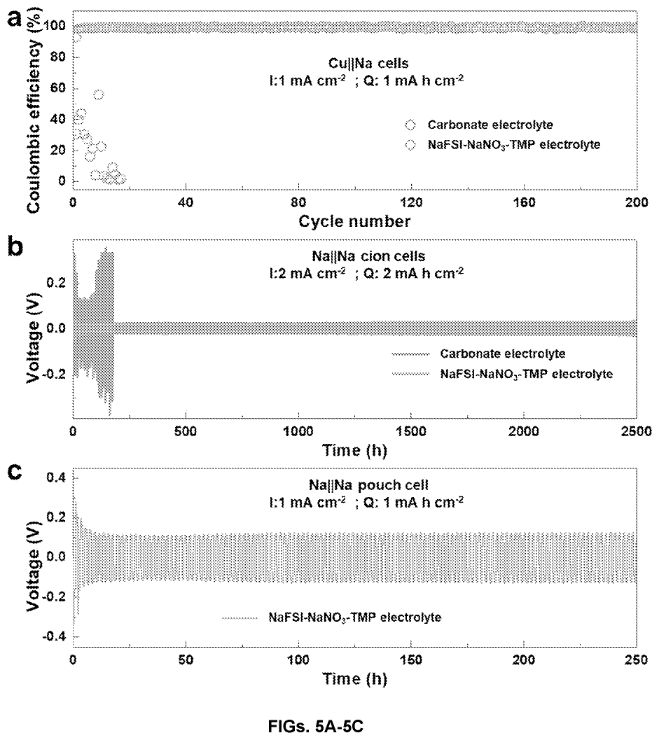

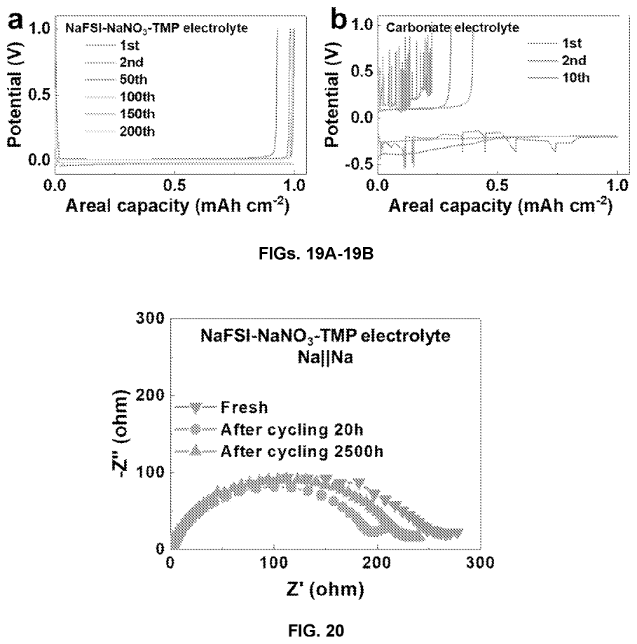

The Coulombic efficiency of Cu∥Na cells is a particularly important parameter to reflect the side reactions between electrolytes and Na. The Coulombic efficiency of the Cu∥Na cell with carbonate electrolyte quickly drops to 3% after 10 cycles (FIG. 5A), which may be due to the intensive side reaction between the carbonate electrolyte and Na. As a comparison, the Cu∥Na cell with NaFSI—NaNO₃-TMP electrolyte shows a well-maintained Coulombic efficiency of 99% after 200 cycles, demonstrating greatly improved Na plating/stripping reversibility. Additionally, the corresponding discharge-charge curves of the Cu∥Na cell with NaFSI—NaNO₃-TMP electrolyte shows a low Na nucleation overpotential with constant, overlapping plateaus during repetitive cycling (FIGS. 19A-19B).

The long-term cycling stability of the Na anode in each electrolyte was further examined with symmetric cells at a current density of 2 mA cm⁻² and an areal capacity of 2 mA h cm⁻². As shown in FIG. 5B, the overpotential of the carbonate electrolyte is >320 mV initially, followed by large voltage fluctuations and a high overpotential, which could be attributed to the uncontrolled SEI breakage and uneven Na deposition. The symmetric cell with NaFSI—NaNO₃-TMP electrolyte displays an overpotential of only 41 mV initially and shows a remarkable lifespan of 2,500 h.

It has been shown that even after cycling for 2,500 h, the symmetric cell still shows an overpotential of as low as 35 mV, which shows better stability compared to many previously published sodium metal-related work (Table 4).

The symmetric cell with NaFSI—NaNO₃-TMP electrolyte exhibits a flat charge/discharge profile with very low and stable overpotential with stable cycling performance, demonstrating that the NaFSI—NaNO₃-TMP electrolyte can construct a stable interface between the electrolyte and Na.

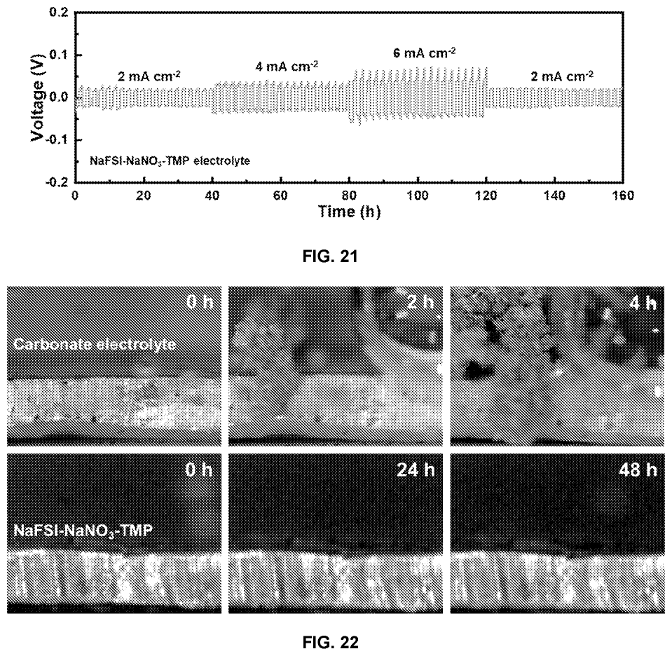

As shown in FIG. 20, the charge-transfer resistance initially decreases from 247Ω (fresh cell) to 184Ω (20 h) and eventually increases to 210Ω (2500 h). The initial decrease in overpotential can be attributed to the reconstruction and formation of the SEI on the Na surface. As shown in FIG. 21, when the current density increases from 2 to 6 mA cm⁻², the overpotential of the Na∥Na symmetric cell with NaFSI—NaNO₃-TMP electrolyte increases by only 40 mV. These results further demonstrate the fast kinetics of NaFSI—NaNO₃-TMP electrolyte and good compatibility with Na-metal anode.

It was found that the symmetric cell with NaFSI—NaNO₃-TMP electrolyte at the pouch cell level also delivers a low overpotential of 105 mV after 250 h at a current density of 1 mA cm⁻² and an areal capacity of 1 mA h cm⁻², as shown in FIG. 5C. Until now, no published result on a Na symmetric cell at the pouch cell level has reported such a highly-stable electrochemical performance. The stable stripping/plating behaviors of the Na symmetric pouch cell further demonstrate the practical viability of NaFSI—NaNO₃-TMP electrolyte.

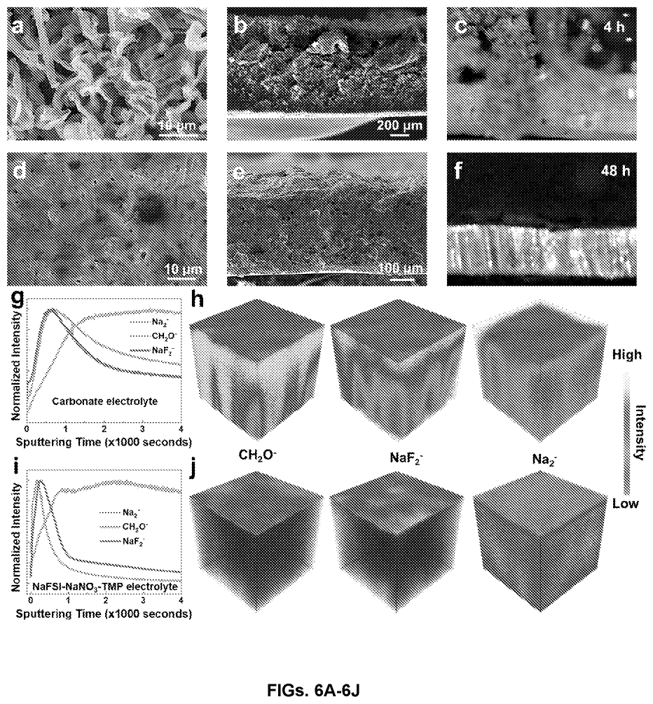

The SEM images of the Na anode disassembled from a Na∥NFM cell with various electrolytes after 100 cycles were obtained to investigate the anode-electrolyte interface further. As shown in FIG. 6A, the surface of the Na anode in the carbonate electrolyte is fully covered by disordered long dendritic Na, indicating an unstable SEI on the Na anode in the carbonate electrolyte. FIG. 6B shows the cross-sectional morphology of Na anode in carbonate electrolyte, which displays a thick layer with a mossy morphology. Such a result indicates poor Na protection from dendritic growth in the carbonate electrolyte and thus leads to poor electrochemical performance. In sharp contrast, the surface of TMP remains smooth after 100 cycles, observed from the top-surface image in FIG. 6D. A compact and uniform layer coated on the Na anode can be detected from the cross-sectional image in FIG. 6E, which thus can effectively suppress dendritic growth.

To further demonstrate the Na anode plating/stripping stability in NaFSI—NaNO₃-TMP electrolyte, optical microscopy on a Na∥Na symmetric cell with a transparent window was employed to visually monitor the Na plating/stripping behavior. As seen in FIG. 6C, the photos of the Na cross-sections were obtained after plating/stripping for 4 h in carbonate electrolyte.

TABLE 4
A comparative analysis of the cycling performances of the symmetric cells.

| | | Plating/ | | | | |
|---|---|---|---|---|---|---|
| | Current | stripping | | | | |
| | density | capacity | Overpot. | Cycling | Cell | |
| Electrolyte | (mA cm⁻²) | (mA h cm⁻²) | (mV) | hour (h) | type | Ref. |
| NaFSI—NaNO₃—TMP | 2 | 2 | 35 | 2500 | Coin | This |
| (1.1M NaFSI and 0.3M | 1 | 1 | 105 | 250 | Pouch | work |
| NaNO₃ in TMP) | | | | | | |
| HCE (5.2M NaFSI in | 2 | 1 | >200 | 600 | Coin | R42 |
| DME) | | | | | | |
| LHCE (2.1M NaFSI in | 2 | 1 | 50 | 960 | Coin | |
| DME—BTFE) | | | | | | |
| LHCE (NaFSI/DME/TTE | 1 | 1 | 26 | 590 | Coin | R43 |
| 1:1.2:1) | | | | | | |
| 0.8M NaPF₆ in | 1 | 5 | 50 | 720 | Coin | R44 |
| TMP/FEC/DTD—E | | | | | | |
| 0.8M NaOTF in | 3 | 1 | 250 | 900 | Coin | R45 |
| THF/DME (3:1) | | | | | | |
| 0.3M NaPF₆ in | 0.5 | 0.5 | 40 | 350 | Coin | R46 |
| EC/PC + 2% BSTFA | | | | | | |
| 1M NaTFSI—TEP/FEC | — | — | 500 | 300 | Coin | R47 |
| (3:1) | | | | | | |
| 1M NaClO₄ in | 2 | 2 | 50 | 1100 | Coin | R48 |
| PC + EC + 0.5M | | | | | | |
| C₆₀(NO₂)₆ | | | | | | |
| LHCE + 1 wt % SbF₃ | 0.5 | 0.5 | 40 | 1200 | Coin | R49 |
| 0.067M Na₂S₆ (PS) | 10 | 1 | 50 | 80 | Coin | R50 |
| additive | | | | | | |
| 1M NaDFOB in | 1.5 | 0.1 | 500 | 515 | Coin | R51 |
| EC/DMC | | | | | | |
| 1M NaPF₆ in DME | 0.25 | 1 | ~20 | 1050 | Coin | R52 |
| 5M NaFSI—DME | 0.0028 | 0.0014 | 20 | 600 | Coin | R53 |
| 1M NaPF₆ in | 1 | 1 | 60 | >900 | Coin | R54 |
| DME/FEC/HFPM | | | | | | |
| 1M NaPF₆ in | 0.5 | 1.0 | 150 | 1100 | Coin | R55 |
| FEC/PC/HFE + 5% PFMP | | | | | | |

As shown in FIG. 22, the surface of the Na in both the carbonate electrolyte and NaFSI—NaNO₃-TMP electrolyte at the beginning is smooth. A precise formation of Na dendrites can be observed on the Na in carbonate electrolyte after plating/stripping at 2 mA cm⁻² and 2 mA h cm⁻² for 2 h. As the cycling time went by (after 4 h), more protrusions were formed on the Na in the carbonate electrolyte, resulting in several huge porous dendrites. Compared to Na in carbonate electrolyte, dendritic structures or fragmentation are not seen in the morphology of Na in NaFSI—NaNO₃-TMP electrolyte even after cycling for 48 h (FIG. 6F), demonstrating that the SEI derived from NaFSI—NaNO₃-TMP electrolyte can effectively protect Na from dendrite growth.

To investigate the chemical composition of the SEI formed on the surface of the Na anode in Na∥NFM cells, TOF-SIMS depth profiles were obtained. The TOF-SIMS depth profiles (normalized to their maximum) of the Na anode surface in carbonate electrolyte (FIG. 6G) or NaFSI—NaNO₃-TMP electrolyte (FIG. 6I) after 100 cycles reveal the depth distribution of various species in the SEI. Here, the Naz species were selected to represent metallic Na. Notably, the thickness of the SEI in the NaFSI—NaNO₃-TMP electrolyte is only one-fifth of that in the carbonate electrolyte, according to the FWHM of the normalized profiles of the SEI species. To clearly illustrate the difference in the thicknesses between the SEIs formed in carbonate electrolyte and NaFSI—NaNO₃-TMP electrolyte, the 3D visualization of architecture evolutions of cycled Na anode is presented in FIG. 6H (carbonate electrolyte) and FIG. 6J (NaFSI—NaNO₃-TMP electrolyte). From FIG. 6H, it is observed that the Na anode surface in the carbonate electrolyte has been fully covered with an organic-rich layer. As shown in FIG. 6H, both the CH₂O⁻ and the NaF₂⁻ show stronger intensity over the whole investigated depth.

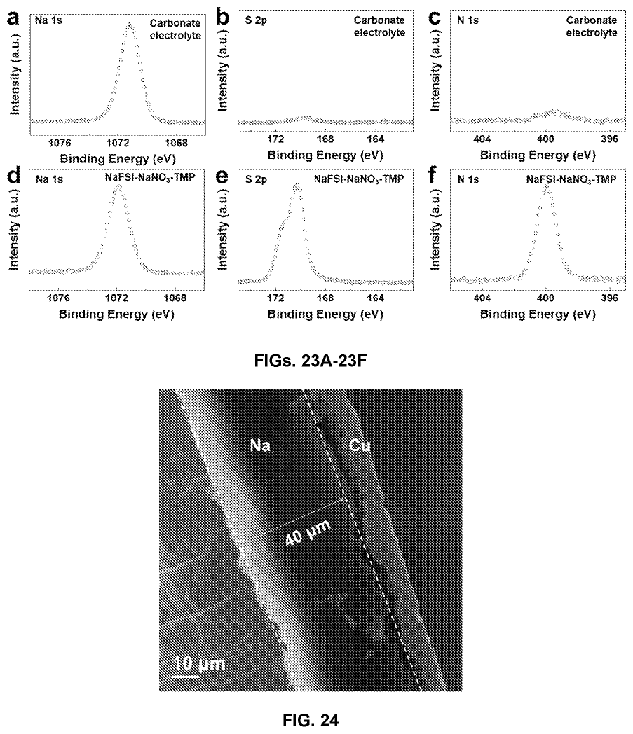

In contrast, the SEI formed in the NaFSI—NaNO₃-TMP electrolyte has less CH₂O⁻ and NaF₂⁻ than the carbonate electrolyte. More importantly, a compact uniform SEI layer can be detected on the Na anode in the NaFSI—NaNO₃-TMP electrolyte, easily reflected by the segregation between the CH₂O⁻ or NaF₂⁻ and Na₂⁻. It is noteworthy that the intensity of NaF₂⁻ derived from salt decomposition is stronger than that of CH₂O⁻ derived from solvent decomposition. This result indicates that the inorganic-derived anions form a robust passivation film. The XPS results in FIGS. 23A-23F further demonstrate the formation of an inorganic-rich SEI on the Na anode in NaFSI—NaNO₃-TMP electrolyte.

### Conclusion

A new advanced electrolyte of 1.1 M NaFSI—NaNO₃-TMP electrolyte has been demonstrated. The low concentration of NaFSI significantly reduces the amount of salt required in HCE and thus cuts the cost of the electrolyte. This result was achieved by introducing NaNO₃ as a substitute for NaFSI. Like the NaFSI salt, the eutectic NaNO₃ diluent molecule strongly interacts with TMP. Without wishing to be bound by any theory, it was suggested that the diluent salt replaces the TMP site in the Na-ion primary solvation shell and facilitates the construction of a compact SEI on both the anode and cathode. Surprisingly, it was found that the 1.1 M NaFSI—NaNO₃-TMP electrolyte with an electrolyte to an active material ratio of only 3.6 μL mg⁻¹ can enable a high-loading Na∥NFM cell to achieve a Coulombic efficiency (CE) of 99.3% and capacity retention of 80% over 500 cycles.

The devices, systems, and methods of the appended claims are not limited in scope by the specific devices, systems, and methods described herein, which are intended as illustrations of a few aspects of the claims. Any devices, systems, and functionally equivalent methods are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention or the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include, means-plus- or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### EXEMPLARY ASPECTS

In view of the described processes and compositions, hereinbelow are described certain more particularly described aspects of the disclosures. These particularly recited aspects should not, however, be interpreted to have any limiting effect on any different claims containing different or more general teachings described herein, or that the “particular” aspects are somehow limited in some way other than the inherent meanings of the language and formulas literally used therein.

Example 1: An electrolyte comprising: a first salt, wherein the first salt is an active material salt; a second salt; and a solvent, wherein the first salt and the second salt are dissolved in the solvent, such that the dissolved first salt has a solvation structure; wherein a solubility of the first salt in the solvent is greater than about 2 M; wherein the second salt is different from the first salt and has a solubility in the solvent lower than about 2 M; wherein the second salt behaves as a diluent and is at least partially incorporated into the solvation structure; such that the solvation structure is substantially dominated by a plurality of solvent-separated pairs, contact-ion pairs, aggregates or a combination thereof.

Example 2: The electrolyte of any examples herein, particularly example 1, wherein the solvent comprises one or more solvents.

Example 3: The electrolyte of any examples herein, particularly example 1 or 2, wherein the solvent is a nonaqueous solvent.

Example 4: The electrolyte of any examples herein, particularly examples 1-3, wherein the first salt comprises one or more active material salts.

Example 5: The electrolyte of any examples herein, particularly examples 1-4, wherein the second salt comprises one or more salts.

Example 6: The electrolyte of any examples herein, particularly examples 1-5, wherein the first salt is present in a concentration from about 1 M to about 2 M.

Example 7: The electrolyte of any examples herein, particularly examples 1-6, wherein the second salt is present in a concentration of less than about 1 M.

Example 8: The electrolyte of any examples herein, particularly examples 1-7, wherein the solvation structure further comprises the solvent that is not associated with the first and/or second salt.

Example 9: The electrolyte of any examples herein, particularly examples 1-8, wherein when the electrolyte is used in an electrochemical cell, the electrolyte is capable of forming an inorganic-rich interface layer on at least one electrochemically active surface during an operation of the electrochemical cell.

Example 10: The electrolyte of any examples herein, particularly examples 1-9, wherein the first salt comprises an alkali-metal cation, an alkaline-earth metal cation, an ammonium cation, a zinc cation, an aluminum cation, a transition-metal cation, an organic cation, or any combination thereof.

Example 11: The electrolyte of any examples herein, particularly examples 1-10, wherein the first salt comprises lithium bis(fluorosulfonyl)imide (LiFSI), lithium bis(trifluoromethanesulfonyl)imide (LiTFSI), lithium bis(pentafluoroethanesulfonyl)imide (LiBETI), lithium bis(oxalato) borate (LiBOB), LiPF₆, LiAsF₆, LiBF₄, LiCF₃SO₃, LiClO₄, lithium difluoro oxalato borate anion (LiDFOB), lithium 4,5-dicyano-2-(trifluoromethyl) imidazolide (LiTDI), sodium bis(fluorosulfonyl)imide (NaFSI), sodium bis(trifluoromethylsulfonyl)imide (NaTFSI), sodium bis(pentafluoroethanesulfonyl)imide (NaBETI), NaPF₆, NaAsF₆, NaBF₄, NaCF₃SO₃, NaClO₄, sodium bis(oxalato) borate (NaBOB), sodium difluoro oxalato borate anion (NaDFOB), potassium bis(fluorosulfonyl)imide (KFSI), potassium bis(trifluoromethylsulfonyl)imide (KTFSI), potassium bis(pentafluoroethanesulfonyl)imide (KBETI), KPF₆, KASF₆, KBF₄, KCF₃SO₃, KClO₄, potassium bis(oxalato) borate (KBOB), potassium difluoro oxalato borate anion (KDFOB), or any combination thereof.

Example 12: The electrolytes of any examples herein, particularly examples 1-11, wherein the solvent is a flame retardant solvent.

Example 13: The electrolyte of any examples herein, particularly example 12, wherein the flame retardant solvent comprises an organic phosphate, an organic phosphite, an organic phosphonate, an organic phosphoramide, a phosphazene, or any combination thereof.

Example 14: The electrolyte of any examples herein, particularly example 12 or 13, wherein the flame retardant solvent comprises trimethyl phosphate, triethyl phosphate, tributyl phosphate, triphenyl phosphate, tris(2,2,2-trifluoroethyl) phosphate, bis(2,2,2-trifluoroethyl) methyl phosphate; trimethyl phosphite, triphenyl phosphite, tris(2,2,2-trifluoroethyl) phosphite; dimethyl methylphosphonate, diethyl ethylphosphonate, diethyl phenylphosphonate, bis(2,2,2-trifluoroethyl)methylphosphonate; hexamethylphosphoramide; hexamethoxyphosphazene, hexafluorophosphazene, or any combination thereof.

Example 15: The electrolyte of any examples herein, particularly examples 1-14, wherein the second salt comprises a cation that is the same or different from a cation of the first salt.

Example 16: The electrolyte of any examples herein, particularly examples 1-15, wherein the second salt comprises LiI, LiBr, LiCl, LiSCN, LiNO₃, LiNO₂, Li₂SO₄, CF₃COOLi, NaI, NaBr, NaCl, NaSCN, NaNO₃, NaNO₂, Na₂SO₄, KI, KBr, KCl, KSCN, KNO₃, KNO₂, K₂SO₄, or any combination thereof.

Example 17: The electrolyte of any examples herein, particularly examples 1-16, wherein the first salt is present in an amount of at least about 20% less when compared with a substantially identical reference electrolyte in the absence of the second salt.

Example 18: The electrolyte of any examples herein, particularly examples 1-17, wherein a ratio of the solvent to the first salt is from about 1:0.5 to about 5:1.

Example 19: The electrolyte of any examples herein, particularly examples 9-18, wherein the inorganic-rich interface layer is substantially uniform and substantially compact.

Example 20: The electrolyte of any examples herein, particularly examples 9-19, wherein the electrochemical cell is configured to provide at least about 100 cycles of stripping/platting.

Example 21: The electrolyte of any examples herein, particularly examples 9-20, wherein the at least one electrochemically active surface is an anode.

Example 22: The electrolyte of any examples herein, particularly examples 9-21, wherein the at least one electrochemically active surface is a current collector configured to serve as an anode during a plating step.

Example 23: The electrolyte of any examples herein, particularly examples 9-22, wherein the at least one electrochemically active surface is a cathode.

Example 24: The electrolyte of any examples herein, particularly examples 9-23, wherein the inorganic-rich interface layer comprises a degradation product of the first salt, the second salt, or a combination thereof.

Example 25: The electrolyte of any examples herein, particularly examples 9-24, wherein the inorganic-rich interface layer comprises at least an anion of the first salt, an anion of the second salt, or a combination thereof.

Example 26: The electrolyte of any examples herein, particularly examples 1-25, wherein an anion of the second salt forms one or more ionic aggregates.

Example 27: The electrolyte of any examples herein, particularly examples 9-26, wherein the electrochemical cell is a battery.

Example 28: An electrochemical cell comprising: at least one electrochemically active surface; the electrolyte of any examples herein, particularly examples 1-27; an inorganic-rich interface layer disposed at the at least one electrochemically active surface during an operation of the electrochemical cell; and wherein the electrochemical cell is configured to provide at least about 100 cycles of stripping/platting.

Example 29: The electrochemical cell of any examples herein, particularly example 28, wherein the at least one electrochemically active surface is an anode surface or a current collector configured to behave as an anode during a platting step.

Example 30: The electrochemical cell of any examples herein, particularly example 29, wherein the at least one electrochemically active surface comprises carbon, silicon, tin, antimony, Li, Na, K, Zn, Ni, Cu, Al, silicon, silicon oxides, Mg, Li alloys, Li intermetallics, Li compounds, Na alloys, Na intermetallics, Na compounds, K alloys, K intermetallics, K compounds or any combination thereof.

Example 31: The electrochemical cell of any examples herein, particularly examples 29-30, wherein substantially no dendrites are formed on the anode surface or the current collector during a plating or stripping cycle.

Example 32: The electrochemical cell of any examples herein, particularly examples 28-31, wherein the at least one electrochemical active surface comprises a cathode.

Example 33: The electrochemical cell of any examples herein, particularly example 32, wherein the cathode is a metal cathode of a composite cathode.

Example 34: The electrochemical cell of any examples herein, particularly example 32 or 33, wherein the cathode comprises layered oxide cathodes, vanadium-based cathode, sulfur-based cathode, manganese-based cathode, rocksalt cathode, disordered rocksalt cathode, lithium-rich cathode, NMC (nickel-manganese-cobalt oxide) cathode, NCA (nickel-cobalt-aluminum oxide) cathode, NFM (nickel-iron-manganese oxide) cathode, LCO (lithium-cobalt oxide) cathode, LFP (lithium iron phosphate) cathode, fluoride-based cathode, sulfur selenium cathode, sulfur cathode, selenium cathode, tellurium cathode, spinels cathode, olivines cathode, or any combination thereof.

Example 35: The electrochemical cell of any examples herein, particularly examples 28-34, wherein the electrochemical cell is a battery comprising two electrochemically active surfaces comprising an anode and a cathode.

Example 36: The electrochemical cell of any examples herein, particularly example 35, wherein the battery is a secondary battery.

Example 37: The electrochemical cell of any examples herein, particularly example 35 or 36, wherein the electrolyte comprises: the first salt comprising NaFSI; the second salt comprising NaNO₃; the solvent comprising trimethyl phosphate; the anode comprises a sodium metal or a sodium ion; and the cathode comprises sodium nickel-iron-manganese oxide.

Example 38: The electrochemical cell of any examples herein, particularly examples 35-37, wherein the battery exhibits a Coulombic efficiency greater than about 99% over at least about 500 cycles.

Example 39: The electrochemical cell of any examples herein, particularly examples 35-38, wherein the battery exhibits a capacity retention of at least about 75% over at least about 500 cycles.

Example 40: The electrochemical cell of any examples herein, particularly examples 32-39, wherein a surface of the cathode is substantially free of cracks during the cell operation.

Example 41: The electrochemical cell of any examples herein, particularly examples 28-40, wherein the electrochemical cell is capable of operating in a temperature range from about −30° C. to about 60° C.

Example 42: A method comprising mixing a first salt, wherein the first salt is an active material salt; a second salt; and a solvent to form the electrolyte of any one of claims 1-27, wherein a solubility of the first salt in the solvent is greater than about 2 M; wherein the second salt is different from the first salt and has a solubility in the solvent lower than about 2 M; wherein the second salt behaves as a diluent and is at least partially incorporated into a solvation structure of the first salt, such that the solvation structure is substantially dominated by a plurality of solvent-separated pairs, contact-ion pairs, aggregates or a combination thereof.

Example 43: A method comprising making the electrochemical cell of any examples herein, particularly examples 28-41, wherein the method comprises placing at least one electrode having an electrochemically active surface into the electrolyte of any examples herein, particularly examples 1-27.

Example 44: Use of the electrolyte of any examples herein, particularly examples 1-27 in an electrochemical cell.

Example 45: Use of the electrolyte of any examples herein, particularly examples 1-27, in manufacturing an electrochemical cell.

Example 46: Use of the electrochemical cell of any examples herein, particularly examples 28-41 in an article.

### REFERENCES

1. Yu, Z. et al. Molecular design for electrolyte solvents enabling energy-dense and long-cycling lithium metal batteries. Nat. Energy. 5, 526-533 (2020).
2. Yan, P. et al. Tailoring grain boundary structures and chemistry of Ni-rich layered cathodes for enhanced cycle stability of lithium-ion batteries. Nat. Energy. 3, 600-605 (2018).
3. Weber, R. et al. Long cycle life and dendrite-free lithium morphology in anode-free lithium pouch cells enabled by a dual-salt liquid electrolyte. Nat. Energy. 4, 683-689 (2019).
4. Manthiram, A. A reflection on lithium-ion battery cathode chemistry. Nat. Commun. 11, 1550 (2020).
5. Su, L., Charalambous, H., Cui, Z. & Manthiram, A. High-efficiency, anode-free lithium-metal batteries with a close-packed homogeneous lithium morphology. Energ. Environ. Sci. 15, 843-854 (2022).
6. Kim, M. S. et al. Langmuir-Blodgett artificial solid-electrolyte interfaces for practical lithium metal batteries. Nat. Energy. 3, 889-898 (2018).
7. You, Y. et al. Insights into the Improved High-Voltage Performance of Li-Incorporated Layered Oxide Cathodes for Sodium-Ion Batteries. Chem, (2018).
8. You, Y. et al. Subzero-Temperature Cathode for a Sodium-Ion Battery. Adv. Mater. 28, 7243-7248 (2016).
9. Zhang, S., Yao, Y. & Yu, Y. Frontiers for Room-Temperature Sodium-Sulfur Batteries. ACS Energy Lett. 6, 529-536 (2021).
10. Seh, Z. W., Sun, J., Sun, Y. & Cui, Y. A Highly Reversible Room-Temperature Sodium Metal Anode. ACS Central Science. 1, 449-455 (2015).
11. Xin, S., Yin, Y., Guo, Y. & Wan, L. A High-Energy Room-Temperature Sodium-Sulfur Battery. Adv. Mater. 26, 1261-1265 (2014).
12. Sun, B. et al. Design Strategies to Enable the Efficient Use of Sodium Metal Anodes in High-Energy Batteries. Adv. Mater., 1903891 (2019).
13. Yang, Z. et al. Fire-Retardant, Stable-Cycling and High-Safety Sodium Ion Battery. Angew. Chem. Int. Ed. 60, 27086-27094 (2021).
14. Gao, H., Xue, L., Xin, S., Park, K. & Goodenough, J. B. A Plastic-Crystal Electrolyte Interface for All-Solid-State Sodium Batteries. Angew. Chem. Int. Ed. 56, 5541-5545 (2017).
15. Wang, H., Wang, C., Matios, E. & Li, W. Facile Stabilization of the Sodium Metal Anode with Additives: Unexpected Key Role of Sodium Polysulfide and Adverse Effect of Sodium Nitrate. Angew. Chem. Int. Ed. 57, 7734-7737 (2018).
16. Lamb, J. & Manthiram, A. Stable Sodium-Based Batteries with Advanced Electrolytes and Layered-Oxide Cathodes. Acs Appl. Mater. Interfaces. 14, 28865-28872 (2022).
17. Fang, W. et al. Stable sodium metal anode enhanced by advanced electrolytes with SbF3 additive. Rare Metals, (2020).
18. Jiang, Y. et al. Artificial Heterogeneous Interface Layer with Boosted Ion Affinity and Diffusion for Na/K-Metal Batteries. Adv. Mater. 34, 2109439 (2022).
19. Zhu, M. et al. Dendrite-Free Sodium Metal Anodes Enabled by a Sodium Benzenedithiolate-Rich Protection Layer. Angew. Chem. Int. Ed. 59, 6596-6600 (2020).
20. Wang, A. et al. Processable and Moldable Sodium-Metal Anodes. Angew. Chem. Int. Ed. 56, 11921-11926 (2017).
21. Cao, R. et al. Enabling room temperature sodium metal batteries. Nano Energy. 30, 825-830 (2016).
22. Zheng, J. et al. Extremely Stable Sodium Metal Batteries Enabled by Localized High-Concentration Electrolytes. Acs Energy Lett. 3, 315-321 (2018).
23. Wang, Y. et al. Enhanced Sodium Metal/Electrolyte Interface by a Localized High-Concentration Electrolyte for Sodium Metal Batteries: First-Principles Calculations and Experimental Studies. Acs Appl. Energ. Mater. 4, 7376-7384 (2021).
24. Jin, Y. et al. Highly Reversible Sodium Ion Batteries Enabled by Stable Electrolyte-Electrode Interfaces. Acs Energy Lett. 5, 3212-3220 (2020).
25. Niu, C. et al. High-energy lithium metal pouch cells with limited anode swelling and long stable cycles. Nat. Energy, (2019).
26. Shi, P. et al. A highly concentrated phosphate-based electrolyte for high-safety rechargeable lithium batteries. Chem. Commun. 54, 4453-4456 (2018).
27. Zeng, Z. et al. A Safer Sodium-Ion Battery Based on Nonflammable Organic Phosphate Electrolyte. Adv. Sci. 3, 1600066 (2016).
28. Jiang, X. et al. A Nonflammable Na⁺-Based Dual-Carbon Battery with Low-Cost, High Voltage, and Long Cycle Life. Adv. Energy Mater. 8, 1802176 (2018).
29. He, J., Bhargav, A., Shin, W. & Manthiram, A. Stable Dendrite-Free Sodium-Sulfur Batteries Enabled by a Localized High-Concentration Electrolyte. J. Am. Chem. Soc. 143, 20241-20248 (2021).
30. Mu, L. et al. Deciphering the Cathode-Electrolyte Interfacial Chemistry in Sodium Layered Cathode Materials. Adv. Energy Mater. 8, 1801975 (2018).
31. Su, L. et al. Multiscale operando X-ray investigations provide insights into electro-chemo-mechanical behavior of lithium intercalation cathodes. Appl. Energy. 299, 117315 (2021).
32. Su, L. et al. Tailoring Electrode-Electrolyte Interfaces in Lithium-Ion Batteries Using Molecularly Engineered Functional Polymers. Acs Appl. Mater. Interfaces. 13, 9919-9931 (2021).
33. Lamb, J., Stokes, L. & Manthiram, A. Delineating the Capacity Fading Mechanisms of Na(Ni_{0.3}Fe_{0.4}Mn_{0.3})O₂ at Higher Operating Voltages in Sodium-Ion Cells. Chem. Mat. 32, 7389-7396 (2020).
34. Lamb, J. & Manthiram, A. Surface-Modified Na(Ni_{0.3}Fe_{0.4}Mn_{0.3})O₂ Cathodes with Enhanced Cycle Life and Air Stability for Sodium-Ion Batteries. Acs Appl. Energ. Mater. 4, 11735-11742 (2021).
35. Lamb, J., Jarvis, K. & Manthiram, A. Molten-Salt Synthesis of O3-Type Layered Oxide Single Crystal Cathodes with Controlled Morphology towards Long-Life Sodium-Ion Batteries. Small, 2106927 (2022).
36. Hafner, J. & Kresse, G. Ab initio molecular-dynamics simulation of the liquid-metal-amorphous-semiconductor transition in germanium. Phys. Rev. B. 49, 14251-14269 (1994).
37. Hafner, J. & Kresse, G. Ab initio molecular dynamics for liquid metals. Phys. Rev. B. 47, 558-561 (1993).
38. Burke, K., Ernzerhof, M. & Perdew, J. P. Generalized Gradient Approximation Made Simple. Phys. Rev. Lett. 77, 3865-3868 (1996).
39. Blöchl, P. E. Projector augmented-wave method. Phys. Rev. B. 50, 17953-17979 (1994).
40. Martínez, L., Andrade, R., Birgin, E. G. & Martínez, J. M. PACKMOL: A package for building initial configurations for molecular dynamics simulations. J. Comput. Chem. 30, 2157-2164 (2009).
41. Pack, J. D. & Monkhorst, H. J. Special points for Brillouin-zone integrations. Phys. Rev. B. 13, 5188-5192 (1976).
42. Zheng, J. et al. Extremely Stable Sodium Metal Batteries Enabled by Localized High-Concentration Electrolytes. ACS Energy Lett. 3: 315-321 (2018).
43. He, J., Bhargav, A., Shin, W. & Manthiram, A. Stable Dendrite-Free Sodium-Sulfur Batteries Enabled by a Localized High-Concentration Electrolyte. J. Am. Chem. Soc. 143: 20241-20248 (2021).
44. Zhu, M. et al. An in-situ formed stable interface layer for high-performance sodium metal anode in a non-flammable electrolyte. Energy Storage Mater. 42: 145-153 (2021).
45. Zhou, J. et al. Low-temperature and high-rate sodium metal batteries enabled by electrolyte chemistry. Energy Storage Mater. 50: 47-54 (2022).
46. Jiang, R. et al. An acetamide additive stabilizing ultra-low concentration electrolyte for long-cycling and high-rate sodium metal battery. Energy Storage Mater. 42: 370-379 (2021).
47. Ma, Y. et al. Delicately Tailored Ternary Phosphate Electrolyte Promotes Ultrastable Cycling of Na₃V₂(PO₄)₂F₃-Based Sodium Metal Batteries. ACS Appl. Mater. Interfaces. 14: 17444-17453 (2022).
48. Li, P. et al. Nitrofullerene as an electrolyte-compatible additive for high-performance sodium metal batteries. Nano Energy. 89: 106396 (2021).
49. Fang, W. et al. Stable sodium metal anode enhanced by advanced electrolytes with SbF3 additive. Rare Metals (2020).
50. Sun, Y. et al. High-Safety Nonaqueous Electrolytes and Interfaces for Sodium-Ion Batteries. Small. 15: 1805479 (2019).
51. Gao, L. et al. Revealing the chemistry of an anode-passivating electrolyte salt for high rate and stable sodium metal batteries. J. Mater. Chem. A. 6: 12012-12017 (2018).
52. Zhou, L. et al. Engineering Sodium-Ion Solvation Structure to Stabilize Sodium Anodes: Universal Strategy for Fast-Charging and Safer Sodium-Ion Batteries. Nano Lett. 20: 3247-3254 (2020).
53. Lee, J. et al. Ultraconcentrated Sodium Bis(fluorosulfonyl)imide-Based Electrolytes for High-Performance Sodium Metal Batteries. ACS Appl. Mater. Interfaces. 9: 3723-3732 (2017).
54. Yi, Q. et al. Fluorinated Ether Based Electrolyte Enabling Sodium-Metal Batteries with Exceptional Cycling Stability. ACS Appl. Mater. Interfaces. 11: 46965-46972 (2019).
55. Zheng, X. et al. Bridging the immiscibility of an all-fluoride fire extinguishant with highly-fluorinated electrolytes toward safe sodium metal batteries. Energy Environ. Sci. 13: 1788-1798 (2020).

1. An electrolyte comprising:
a first salt, wherein the first salt is an active material salt,
a second salt, and
one or more solvents,
wherein the first salt and the second salt are dissolved in the one or more solvents such that the dissolved first salt has a solvation structure; and wherein the second salt comprises a cation that is the same or different from a cation of the first salt;
wherein a solubility of the first salt in the one or more solvents is greater than 2 M;
wherein the second salt is different from the first salt and has a solubility in the one or more solvents lower than 2 M;
wherein the second salt behaves as a diluent and is at least partially incorporated into the solvation structure, such that the solvation structure is substantially dominated by a plurality of solvent-separated pairs, contact-ion pairs, aggregates or a combination thereof.

2. (canceled)

3. The electrolyte of claim 1, wherein the solvent is a nonaqueous solvent.

4. The electrolyte of claim 1, wherein the first salt comprises one or more active material salts and/or wherein the second salt comprises one or more salts.

5. (canceled)

6. The electrolyte of claim 1, wherein the first salt is present in a concentration from 1 M to 2 M, and/or wherein the second salt is present in a concentration of less than 1 M.

7. (canceled)

8. The electrolyte of claim 1, wherein the solvation structure further comprises the solvent that is not associated with the first and/or second salt.

9. The electrolyte of claim 1, wherein when the electrolyte is used in an electrochemical cell, the electrolyte forms an inorganic-rich interface layer on at least one electrochemically active surface during an operation of the electrochemical cell, wherein the inorganic-rich interface layer is substantially uniform and substantially compact; and wherein
the inorganic-rich interface layer comprises a degradation product of the first salt, the second salt, or a combination thereof; and/or wherein
the inorganic-rich interface layer comprises at least an anion of the first salt, an anion of the second salt, or a combination thereof.

10. The electrolyte of claim 1, wherein the first salt and/or second salt comprises an alkali-metal cation, an alkaline-earth metal cation, an ammonium cation, a zinc cation, an aluminum cation, a transition-metal cation, an organic cation, or any combination thereof.

11. The electrolyte of claim 1, wherein the first salt comprises lithium bis(fluorosulfonyl)imide (LiFSI), lithium bis(trifluoromethanesulfonyl)imide (LiTFSI), lithium bis(pentafluoroethanesulfonyl)imide (LiBETI), lithium bis(oxalato) borate (LiBOB), LiPF₆, LiAsF₆, LiBF₄, LiCF₃SO₃, LiClO₄, lithium difluoro oxalato borate anion (LiDFOB), lithium 4,5-dicyano-2-(trifluoromethyl) imidazolide (LiTDI), sodium bis(fluorosulfonyl)imide (NaFSI), sodium bis(trifluoromethylsulfonyl)imide (NaTFSI), sodium bis(pentafluoroethanesulfonyl)imide (NaBETI), NaPF₆, NaAsF₆, NaBF₄, NaCF₃SO₃, NaClO₄, sodium bis(oxalato) borate (NaBOB), sodium difluoro oxalato borate anion (NaDFOB), potassium bis(fluorosulfonyl)imide (KFSI), potassium bis(trifluoromethylsulfonyl)imide (KTFSI), potassium bis(pentafluoroethanesulfonyl)imide (KBETI), KPF₆, KAsF₆, KBF₄, KCF₃SO₃, KClO₄, potassium bis(oxalato) borate (KBOB), potassium difluoro oxalato borate anion (KDFOB), or any combination thereof.

12. The electrolyte of claim 1, wherein the one or more solvents are a flame retardant solvent comprising an organic phosphate, an organic phosphite, an organic phosphonate, an organic phosphoramide, a phosphazene, or any combination thereof.

13. (canceled)

14. The electrolyte of claim 12, wherein the flame retardant solvent comprises trimethyl phosphate, triethyl phosphate, tributyl phosphate, triphenyl phosphate, tris(2,2,2-trifluoroethyl) phosphate, bis(2,2,2-trifluoroethyl) methyl phosphate; trimethyl phosphite, triphenyl phosphite, tris(2,2,2-trifluoroethyl) phosphite; dimethyl methylphosphonate, diethyl ethylphosphonate, diethyl phenylphosphonate, bis(2,2,2-trifluoroethyl)methylphosphonate; hexamethylphosphoramide; hexamethoxyphosphazene, hexafluorophosphazene, or any combination thereof.

15. (canceled)

16. The electrolyte of claim 1, wherein the second salt comprises LiI, LiBr, LiCl, LiSCN, LiNO₃, LiNO₂, Li₂SO₄, CF₃COOLi, NaI, NaBr, NaCl, NaSCN, NaNO₃, NaNO₂, Na₂SO₄, KI, KBr, KCl, KSCN, KNO₃, KNO₂, K₂SO₄, or any combination thereof.

17. The electrolyte of claim 1, wherein the first salt is present in an amount of at least about 20% less when compared with a substantially identical reference electrolyte in the absence of the second salt.

18. The electrolyte of claim 1, wherein a ratio of the one or more solvents to the first salt is from about 1:1 to about 5:1.

19. (canceled)

20. The electrolyte of claim 9, wherein the electrochemical cell is configured to provide at least about 100 cycles of stripping/platting.

21. (canceled)

22. (canceled)

23. (canceled)

24. (canceled)

25. (canceled)

26. The electrolyte of claim 1, wherein an anion of the second salt forms one or more ionic aggregates.

27. (canceled)

28. An electrochemical cell comprising:
at least one electrochemically active surface, wherein the at least one electrochemically active surface is an anode surface or a current collector configured to behave as an anode during a plating step
the electrolyte of claim 1,
an inorganic-rich interface layer disposed at the at least one electrochemically active surface during an operation of the electrochemical cell,
wherein the electrochemical cell is configured to provide at least about 100 cycles of stripping/plating; and
wherein substantially no dendrites are formed on the anode surface or the current collector during a plating or stripping cycle.

29. (canceled)

30. The electrochemical cell of claim 28, wherein the anode comprises carbon, silicon, tin, antimony, Li, Na, K, Zn, Ni, Cu, Al, silicon, silicon oxides, Mg, Li alloys, Li intermetallics, Li compounds, Na alloys, Na intermetallics, Na compounds, K alloys, K intermetallics, K compounds or any combination thereof.

31. (canceled)

32. The electrochemical cell of claim 28, the electrochemical cell further comprises a cathode, and wherein the cathode comprises layered oxide cathodes, vanadium-based cathode, sulfur-based cathode, manganese-based cathode, rocksalt cathode, disordered rocksalt cathode, lithium-rich cathode, NMC (nickel-manganese-cobalt oxide) cathode, NCA (nickel-cobalt-aluminum oxide) cathode, NFM (nickel-iron-manganese oxide) cathode, LCO (lithium-cobalt oxide) cathode, LFP (lithium iron phosphate) cathode, fluoride-based cathode, sulfur selenium cathode, sulfur cathode, selenium cathode, tellurium cathode, spinels cathode, olivines cathode, or any combination thereof;
and wherein the electrochemical cell:
exhibits a Coulombic efficiency greater than 99% over at least 500 cycles and/or
exhibits a capacity retention of at least 75% over at least 500 cycles.

33. (canceled)

34. (canceled)

35. (canceled)

36. (canceled)

37. The electrochemical cell of claim 32, wherein
the electrolyte comprises:
the first salt comprising NaFSI;
the second salt comprising NaNO₃,
the one or more solvents comprising trimethyl phosphate;
the anode comprises a sodium metal or a sodium ion; and
the cathode comprises sodium nickel-iron-manganese oxide.

38. (canceled)

39. (canceled)

40. (canceled)

41. (canceled)

42. A method comprising mixing a first salt, wherein the first salt is an active material salt; a second salt; and one or more solvents to form the electrolyte of claim 1, wherein a solubility of the first salt in the solvent is greater than 2 M; wherein the second salt is different from the first salt and has a solubility in the solvent lower than 2 M; wherein the second salt behaves as a diluent and is at least partially incorporated into a solvation structure of the first salt, such that the solvation structure is substantially dominated by a plurality of solvent-separated pairs, contact-ion pairs, aggregates or a combination thereof.

43. (canceled)

44. (canceled)

45. (canceled)

46. (canceled)
